(19) United States
(12) Patent Application Publication
(10) Pub. No.: US 2023/0267628 A1
(43) Pub. Date: Aug. 24, 2023

(54) DECODING AN IMAGE FOR ACTIVE DEPTH SENSING TO ACCOUNT FOR OPTICAL DISTORTIONS

(71) Applicant: QUALCOMM Incorporated, San Diego, CA (US)

(72) Inventors: Ioannis NOUSIAS, San Diego, CA (US); Matthieu Jean Olivier DUPRE, La Jolla, CA (US)

(21) Appl. No.: 18/005,106

(22) PCT Filed: Sep. 20, 2021
(86) PCT No.: PCT/US2021/051127

§ 371 Date: Jan. 11, 2023

(30) Foreign Application Priority Data
Sep. 23, 2020 (GR) 20200100573

(51) Int. Cl. G06T 7/521; G06T 7/11

(52) U.S. Cl. CPC G06T 7/521; G06T 7/11

(57) ABSTRACT

Aspects of the disclosure relate to decoding an image for active depth sensing. An example method includes receiving an image. The image includes one or more reflections of a distribution of light. The method also includes sampling a first region of the image using a first sampling grid to generate a first image sample, sampling a second region of the image using a second sampling grid different from the first sampling grid to generate a second image sample, determining a first depth value based on the first image sample, and determining a second depth value based on the second image sample.

### TECHNICAL FIELD

This disclosure relates generally to active depth sensing systems and devices, such as decoding an image for active depth sensing to account for the effects of optical distortions.

### BACKGROUND

Many devices include an active depth sensing system. For example, a smartphone may include a front facing active depth sensing transmitter to project light (such as for face unlock or other applications using depth information) and an image sensor to capture reflections of the light projected by the transmitter. The transmitter may project a predefined distribution of light, and depths of objects in a scene may be determined based on reflections of the distribution of light captured by the image sensor. Such active depth sensing technique may be referred to as structured light depth sensing.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

An example device for active depth sensing includes a memory and one or more processors. The one or more processors are configured to receive an image. The image includes one or more reflections of a distribution of light. The one or more processors are also configured to: sample a first region of the image using a first sampling grid; sample the first region of the image using a second sampling grid, the second sampling grid being different from the first sampling grid; determine a first confidence value associated with the first sampling grid and a second confidence value associated with the second sampling grid; and based on the first confidence value being greater than the second confidence value, select the first sampling grid for use in determining a first depth value for the first region.

An example method for active depth sensing is provided. The method includes: receiving an image including one or more reflections of a distribution of light; sampling a first region of the image using a first sampling grid; sampling the first region of the image using a second sampling grid, the second sampling grid being different from the first sampling grid; determining a first confidence value associated with the first sampling grid and a second confidence value associated with the second sampling grid; and based on the first confidence value being greater than the second confidence value, selecting the first sampling grid for use in determining a first depth value for the first region.

An example non-transitory computer readable medium stores instructions that, when executed by one or more processors of a device, cause the device to: receive an image, the image including one or more reflections of a distribution of light; sample a first region of the image using a first sampling grid; sample the first region of the image using a second sampling grid, the second sampling grid being different from the first sampling grid; determine a first confidence value associated with the first sampling grid and a second confidence value associated with the second sampling grid; and based on the first confidence value being greater than the second confidence value, select the first sampling grid for use in determining a first depth value for the first region.

Another example device for active depth sensing includes: means for receiving an image including one or more reflections of a distribution of light; means for sampling a first region of the image using a first sampling grid; means for sampling the first region of the image using a second sampling grid, the second sampling grid being different from the first sampling grid; means for determining a first confidence value associated with the first sampling grid and a second confidence value associated with the second sampling grid; and means for based on the first confidence value being greater than the second confidence value, selecting the first sampling grid for use in determining a first depth value for the first region.

In some aspects, the distribution of light is a distribution of light points.

In some aspects, the method, devices, and computer-readable medium described above further comprise: determining a first image sample based on the sampling of the first region of the image using the first sampling grid; and determining the first depth value for the first region based on the first image sample.

In some aspects, the method, devices, and computer-readable medium described above further comprise: identifying in the first region a first codeword in an array of the distribution of light based on the first image sample; and determining a first disparity based on a location of the first codeword in the array, wherein determining the first depth value is based on the first disparity.

In some aspects, the method, devices, and computer-readable medium described above further comprise: sampling a second region of the image using a third sampling grid to generate a second image sample; and determining a second depth value based on the second image sample.

In some aspects, an arrangement of sampling points of the second sampling grid differs from an arrangement of sampling points of the first sampling grid.

In some aspects, the arrangement of sampling points of the first sampling grid includes a first spacing between sampling points of the first sampling grid, and the arrangement of sampling points of the second sampling grid includes a second spacing between sampling points of the second sampling grid.

In some aspects, the first spacing and the second spacing are along a baseline axis and an axis orthogonal to the baseline axis, the baseline axis being associated with a transmitter that transmits the distribution of light and a receiver that captures the image.

In some aspects, a total number of sampling points of the second sampling grid differs from a total number of sampling points of the first sampling grid.

In some aspects, the first sampling grid is an isotropic sampling grid and the second sampling grid is an anisotropic sampling grid.

In some aspects, the method, devices, and computer-readable medium described above further comprise: determining a first image sample based on the sampling of the first region of the image using the first sampling grid; determining a second image sample based on the sampling of the first region of the image using the second sampling grid; compare the first image sample and the second image sample; and select the first image sample to be used for determining the first depth value based on comparing the first image sample and the second image sample.

In some examples, to determine the first confidence value associated with the first sampling grid, the method, devices, and computer-readable medium described above can include determining the first confidence value for the first image sample. In some examples, to determining the second confidence value associated with the second sampling grid, the method, devices, and computer-readable medium described above can include determining the second confidence value for the second image sample. In some examples, the method, devices, and computer-readable medium described above can include selecting the first sampling grid for use in determining the first depth value for the first region, the one or more processors are configured to select the first image sample based on the first confidence value being greater than the second confidence value.

In some aspects, the device includes a receiver configured to capture the image.

In some aspects, the device includes a transmitter configured to transmit the distribution of light, wherein the transmitter is separated from the receiver by a baseline distance along a baseline axis.

In some aspects, the device includes one or more signal processors configured to process the image before decoding the processed image by the one or more processors.

In some aspects, the method, devices, and computer-readable medium described above further comprise generating a depth map based on the image, wherein the depth map includes a plurality of depth values including the first depth value, and wherein the plurality of depth values indicate one or more depths of one or more objects in a scene captured in the image.

In some aspects, the device is, is part of, and/or includes a mobile device (e.g., a mobile telephone or so-called “smart phone” or other mobile device), a wearable device, an extended reality device (e.g., a virtual reality (VR) device, an augmented reality (AR) device, or a mixed reality (MR) device), a camera, a personal computer, a laptop computer, a server computer, a vehicle or a computing device or component of a vehicle, a robotics device or system, a television, or other device. In some aspects, the device includes a camera or multiple cameras for capturing one or more images. In some aspects, the device includes a display for displaying one or more images, notifications, and/or other displayable data. In some aspects, the device can include one or more sensors (e.g., one or more inertial measurement units (IMUs), such as one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Aspects of the present disclosure are illustrated by way of example, and not by way of limitation, in the figures of the accompanying drawings and in which like reference numerals refer to similar elements.

FIG. 1 shows a depiction of an example active depth sensing system using a predetermined distribution of light, in accordance with some examples.

FIG. 2 shows a depiction of an example distribution for active depth sensing, in accordance with some examples.

FIG. 3 shows a depiction of an example distribution including a pincushion distortion, in accordance with some examples.

FIG. 4 shows a block diagram of an example device for active depth sensing, in accordance with some examples.

FIG. 5 shows a block diagram of an example decoding process for active depth sensing, in accordance with some examples.

FIG. 6 shows a depiction of an example sampling grid, in accordance with some examples.

FIG. 7 shows a depiction of an example distribution of light points in a rectified image, in accordance with some examples.

FIG. 8 shows an example depiction of locations identified in a projected distribution for an image during active depth sensing, in accordance with some examples.

FIG. 9 shows an illustrative flow chart depicting an example process of decoding an image for active depth sensing, in accordance with some examples.

FIG. 10 shows an example depiction of a first sampling grid and a second sampling grid with different spacings between neighboring sampling points, in accordance with some examples.

FIG. 11 shows an example depiction of a first sampling grid and a second sampling grid with different skews, in accordance with some examples.

FIG. 12 shows a block diagram of an example decoding process using different sampling grids, in accordance with some examples.

FIG. 13 shows an example graph depicting a relationship between a theoretical spacing between sampling points to a disparity measurement for accurately sampling a region of an image, in accordance with some examples.

FIG. 14 shows an example depiction of a square lattice of light points and a hexagonal lattice of light points, in accordance with some examples.

FIG. 15 shows an example depiction of displacements of light points in a distribution caused by distortion, in accordance with some examples.

FIG. 16 shows an illustrative flow chart depicting an example process of decoding an image for active depth sensing, in accordance with some examples.

### DETAILED DESCRIPTION

Aspects of the present disclosure may be used for active depth sensing systems and devices. For structured light depth sensing, one or more components of a transmitter may cause optical distortions in the distribution of light emitted by the transmitter. Such optical distortions may affect locations on the image sensor of where reflections of the distribution of light are received. For example, a reflection of a portion of the distribution of light may be expected to be received at a first portion of the image sensor, but the reflection may be received at a second portion of the image sensor based on the optical distortions (thus displacing the reflection from a first location to a second location on the image sensor). The distribution of light may also be warped based on the optical distortions (such as the distribution of light including a pincushion distortion). One or more depth values may not be determined or may be erroneously determined during active depth sensing as a result of the optical distortions. Some aspects of the present disclosure include decoding to reduce the effects of optical distortions on determining depth values for active depth sensing.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure. Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing.” “receiving,” “sending,” “using,” “selecting,” “determining,” “normalizing,” “multiplying,” “averaging,” “monitoring,” “comparing,” “applying,” “updating,” “measuring,” “deriving,” “settling” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices. In some implementations, as used herein, “determining,” “generating,” or other similar terms may be used interchangeably.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any suitable electronic device for decoding information from images for active depth sensing. A device may include any number of image sensors configured to capture the images (including zero image sensors for a device to receive image frames from another device or component) or any number of emitters configured for active depth sensing (including zero emitters for a device separate from a transmission device or component for active depth sensing). Example devices include security systems, smartphones, tablets, laptop computers, digital cameras, unmanned or autonomous vehicles, and so on). While many examples described herein depict a device including an emitter and an image sensor, the device may have one, both, or neither component, or the device may have multiple instances of either component. Therefore; the present disclosure is not limited to devices having a specific number of image sensors, active depth sensing emitters, components, orientation of components, and so on.

The term “device” is not limited to one or a specific number of physical objects (such as one smartphone, one camera controller, one processing system and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. Similarly, the term “system” is not limited to one or a specific number of physical objects (such as one or more devices, one or more smartphones, one or more camera controllers, one or more processing systems; and so on). As used herein, a system may be any number of devices or a portion of a device that may implement at least some portions of the disclosure. While the below description and examples may use the term “system” to describe various aspects of the disclosure, the term “system” is not limited to a specific configuration, type, or number of objects. As such, “device” and “system” may be used interchangeably to refer similar aspects of the disclosure.

One type of active depth sensing system includes emitting a predefined (known) distribution of light towards objects in a scene and capturing the reflections of the distribution of light in an image. The image is analyzed to identify reflections of the distribution of light, and the identified reflections are used to determine depths of one or more objects in the scene. A depth value may be determined based on a location of a portion of the reflections in the image, and the depth value may represent or indicate a depth (such as a number corresponding to a distance in meters, feet, or other suitable unit of measurement, a variable used to identify a distance, and so on).

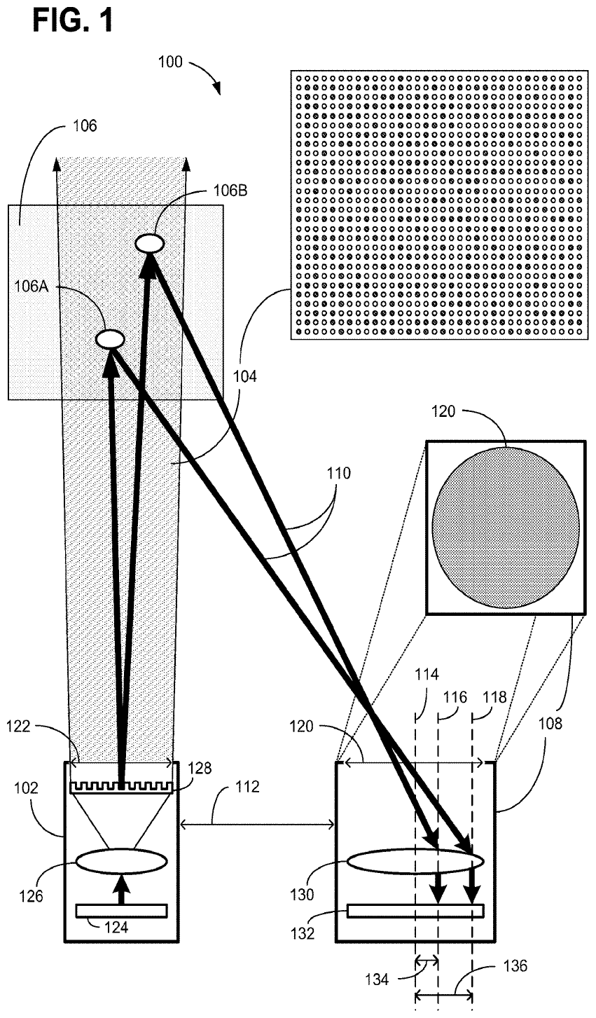

FIG. 1 shows a depiction of an example active depth sensing system 100 using a predetermined (known) distribution 104 of light. The active depth sensing system 100 (which herein also may be referred to as a structured light system or a structured light depth sensing system) may be used to determine one or more depths of objects in a scene 106. The depths of the objects may then be used for any suitable application. For example, the scene 106 may include a face, and the active depth sensing system 100 may be used for identifying or authenticating the face for screen unlock or security purposes.

The active depth sensing system 100 may include an emitter 102 and a receiver 108. The emitter 102 may be referred to as a “transmitter,” “projector,” and so on, and should not be limited to a specific transmission component. Throughout the following disclosure, the terms projector and emitter may be used interchangeably. The receiver 108 may be referred to as a “detector,” “sensor,” “image sensor,” “sensing element,” “photodetector,” and so on, and should not be limited to a specific receiving component.

While the disclosure refers to the distribution as a light distribution, any suitable wireless signals at other frequencies may be used (such as radio frequency waves, sound waves, etc.). Further, while the disclosure refers to the distribution as including a plurality of light points, the light may be focused into any suitable size and dimensions. For example, the light may be projected in lines, squares, or any other suitable dimension.

The distribution 104 may be a codeword distribution, where a defined portion of the distribution (such as a predefined patch of light points) is referred to as a codeword. If the distribution of the light points is known, the codewords of the distribution may be known. In some implementations, a memory may include a library of codewords for the codewords included in the distribution 104 emitted by the emitter 102. The library of codewords may then be used to identify codewords in reflections of the light emitted by the emitter 102 as received by the receiver 108, and the location of the codewords on the receiver's sensor (indicated by the location of the codewords in an image captured by the receiver's sensor) may be used to determine one or more depths in the scene. For example, an image sensor 132 may be configured to capture images including reflections of a codeword distribution emitted by the associated emitter 102. A library of codewords corresponding to the codeword distribution of the light emitted by the emitter 102 may be used in identifying codewords in the reflections of the codeword distribution in the images from the image sensor 132, and the locations are used to determine depths of one or more objects in the scene 106. The distribution of the wireless signals that are emitted may be organized and used in any way, and the present disclosure should not be limited to a specific type of distribution or type of wireless signal.

As illustrated, the emitter 102 may be configured to project a distribution 104 of light points onto the scene 106. Black circles in the distribution 104 may indicate where no light is projected for a possible point location, and white circles in the distribution 104 may indicate where light is projected for a possible point location. In some example implementations, the emitter 102 may include one or more light sources 124 (such as one or more lasers), a lens 126, and a light modulator 128. The light source 124 may include any suitable light source. In some example implementations, the light source 124 may include one or more distributed feedback (DFB) lasers. In some other example implementations, the light source 124 may include one or more vertical cavity surface-emitting lasers (VCSELs). In some examples, the one or more light sources 124 include a VCSEL array, DFB laser array, or another suitable laser array of a plurality of lasers In some other examples, the one or more light sources 124 include any suitable array of appropriate light or wave sources, such as a light emitting diode (LED) array, ultrasound transducer array, or an array of antennas (such as for transmitting radio frequencies or other suitable wave frequencies). While the examples may describe the light source 124 as including an array of lasers for clarity in explaining aspects of the present disclosure, the present disclosure is not limited to a specific configuration or type of light or wave source.

The lasers of the light source 124 may be configured to emit infrared (IR) light. As used herein, IR light may include portions of the visible light spectrum and/or portions of the light spectrum that is not visible to the naked eye. In one example, IR light may include near infrared (NIR) light, which may or may not include light within the visible light spectrum, and/or IR light that is outside the visible light spectrum (such as far infrared (FIR) light). The term IR light should not be limited to light having a specific wavelength in or near the wavelength range. Further, IR light is provided as an example emission for active depth sensing. In the following description, other suitable wavelengths of light may be emitted by the light source 124 (or captured by the image sensor 132 or otherwise used for active depth sensing). As such, active depth sensing is not limited to the use of IR light or a specific frequency of IR light.

The emitter 102 includes an aperture 122 from which the emitted light escapes the emitter 102 onto the scene 106. In some implementations, the emitter 102 includes one or more diffractive optical elements (DOEs) to diffract the emissions from the light source 124 into additional emissions. In some aspects, the light modulator 128 (which may adjust the intensity of the emission) may include one or more DOEs. A DOE includes a material situated in the projection path of the light points from one or more lasers of the light source 124, and the material may be configured to split the light points into additional light points. For example, the material of the DOE may be a translucent or a transparent polymer with a known refractive index. The surface of the DOE may include peaks and valleys (varying the depth of the DOE) so that a light point splits into multiple light points when the light passes through the DOE. The DOE may receive one or more lights points from one or more lasers and project a greater number of light points to cover a larger area of the scene 106 than would be covered by just the one or more light points from the one or more lasers. In projecting the distribution 104 of light points onto the scene 106, the emitter 102 may output one or more light points from the light source 124 through the lens 126 and through a DOE onto the scene 106. In this manner, the distribution 104 may include a repetition of the same distribution of light points at different portions of the distribution 104. For example, the distribution 104 may include a pattern of m rows×n columns of the light distribution emitted by the light source 124 (for integers m and n greater than or equal to one).

As noted above, the light projected by the emitter 102 may be IR light. IR light is provided as an example emission from the emitter 102. In the following description, other suitable wavelengths of light may be used. For example, light in portions of the visible light spectrum outside the IR light wavelength range or ultraviolet light may be output by the emitter 102. Alternatively, other signals with different wavelengths may be used, such as microwaves, radio frequency signals, and other suitable signals.

The scene 106 may include objects at different depths from the structured light system (such as from the emitter 102 and the receiver 108). For example, objects 106A and 106B in the scene 106 are at different depths. The receiver 108 may be configured to receive, from the scene 106, reflections 110 of the transmitted distribution 104 of light points. To receive the reflections 110, the image sensor 132 of the receiver 108 may capture an image. When capturing the image, the receiver 108 receives the reflections 110, as well as (i) other reflections of the distribution 104 of light points from other portions of the scene 106 at different depths and (ii) ambient light. The active depth sensing system 100 may be configured to filter or reduce the ambient light interference to isolate the reflections of the distribution 104 in the captured image (such as by using a bandpass filter or other suitable component to allow the reflections to be received at the image sensor 132 of the receiver 108).

As illustrated, the emitter 102 may be positioned on the same reference plane as the receiver 108, and the emitter 102 and the receiver 108 may be separated by a distance called the baseline (112). In some other implementations, the emitter 102 and the receiver 108 may be positioned on different reference planes. For example, the emitter 102 may be positioned on a first reference plane, and the receiver 108 may be positioned on a second reference plane. The first reference plane and the second reference plane may be the same reference plane, may be parallel reference planes separated from each other, or may be reference planes that intersect at a non-zero angle. The angle and location of the intersection on the reference planes is based on the locations and orientations of the reference planes with reference to each other. The reference planes may be oriented to be associated with a common side of the device. For example, both reference planes (whether parallel or intersecting) may be oriented to receive light from a common side of a device including the active depth sensing system 100 (such as a front side of a smartphone including a display, a top side of the smartphone, and so on).

In device production, minor differences or errors in manufacturing may cause differences in orientation or positioning of the first reference plane or the second reference plane. In one example, mounting the emitter 102 or the receiver 108 on a printed circuit board (PCB) may include an error (within a tolerance) that the orientation of the emitter 102 or the receiver 108 differs from the orientation of the PCB. In another example, orientations of different PCBs including the emitter 102 and the receiver 108 may differ slightly than as designed (such as a slight variation in orientations when the PCBs are designed to be along a same reference plane or parallel to one another). A first reference plane and a second reference plane may be referred to as being the same reference plane, parallel reference planes, or intersecting reference planes as intended through device design without regard to variations in the orientations of the reference planes as a result of manufacturing, calibration, and so on in producing the device.

The receiver 108 includes an aperture 120 to receive light from the scene 106 (including reflections 110). In some example implementations, the receiver 108 may include a lens 130 to focus or direct the received light (including the reflections 110 from the objects 106A and 106B) on to the image sensor 132 of the receiver 108. Assuming for the example that only the reflections 110 are received, depths of the objects 106A and 106B may be determined based on the baseline 112, displacements of the light distribution 104 (such as in codewords) in the reflections 110, and intensities of the reflections 110. For example, the difference 134 between location 116 and the center 114 of the image sensor 132 is used in determining a depth of the object 106B in the scene 106. Similarly, the difference 136 between location 118 and the center 114 of the image sensor 132 is used in determining a depth of the object 106A in the scene 106. The difference 134 or 136 may be measured in terms of number of pixels of the sensor 132 (such as number of pixels in a captured image) or in terms of a distance (such as in millimeters).

In some example implementations, the image sensor 132 may include an array of photodiodes (such as avalanche photodiodes) for capturing an image. To capture the image, each photodiode in the array may capture the light that hits a photosensitive surface associated with the photodiode and may provide a value indicating the intensity of the light (a capture value). The image therefore may be a representation of the capture values provided by the array of photodiodes.

In addition, or alternative to the image sensor 132 including an array of photodiodes, the sensor 132 may include a complementary metal-oxide semiconductor (CMOS) sensor or a charge coupled device (CCD) sensor. To capture the image by a photosensitive sensor (such as a CMOS or CCD sensor), each pixel of the sensor may capture the light that hits the pixel and may provide a value indicating the intensity of the light. In some example implementations, an array of photodiodes may be coupled to the sensor. In this manner, the electrical impulses generated by the array of photodiodes may trigger the corresponding pixels of the sensor to provide capture values (or values converted to capture values by an analog front end coupled to the image sensor 132). While the examples may describe the sensor as being a CMOS sensor for clarity in explaining aspects of the present disclosure, the present disclosure is not limited to a specific sensor type or configuration of components.

As an object moves closer to the receiver 108, the difference on the image sensor 132 that is associated with the object increases. As illustrated, the difference 134 (corresponding to the reflections 110 from the object 106B) is less than the difference 136 (corresponding to the reflections 110 from the object 106A). As such, object 106A is closer to the receiver 108 than object 106B. The difference is illustrated in FIG. 1 along a line representing the image sensor 132. However, the image sensor 132 receives light along a two dimensional plane segment (such as a rectangle). Therefore, the difference may be visualized in a two dimensional manner. The component of the difference along the same axis as the baseline 112 may be referred to as a disparity. The component of the difference 90 degrees to the axis of the baseline 112 (referred to as orthogonal to the baseline) may be referred to as an orthogonal difference. In an ideal sensor that is perfectly aligned and calibrated to the transmitter such that there is no angular difference between the transmitter and the sensor, the orthogonal difference is null for an object positioned at different depths from the sensor (while the disparity changes based on the change in depth). In this manner, the disparity component (which is associated with the baseline 112) is used in determining an object's depth from the receiver 108.

The disparity component is determined by identifying a codeword in the reflections in an image from the image sensor 132, determining the location of the identified codeword in the image, determining the location of the identified codeword in the distribution 104 projected by the emitter 102, determining a corresponding location in a diffracted array (e.g., duplicated versions of the distribution 104), and determining or measuring a distance (e.g., in pixels or subpixels) between the diffracted-array region and the image-region along the baseline 112 axis. The disparity component represents the difference between the location in the image and the location in the emitted distribution 104 (or diffracted array). Referring back to objects 106A and 106B, using triangulation based on the baseline 112 and the disparity components of the differences 134 and 136, the differing depths (such as depth values) of objects 106A and 106B in the scene 106 may be determined.

As noted above, one or more DOEs may be used to duplicate a distribution (such as a distribution of light points from a laser array) to generate a larger distribution (such as a larger distribution of light points projected by the emitter 102 than originally emitted by the laser array). In this manner, a smaller light source (such as a smaller VCSEL array) may be used to cover a similar size portion of a scene for active depth sensing. However, since the original distribution may be duplicated using one or more DOEs, the projected distribution is not unique across its entirety. The unique portion (such as the size of the VCSEL array) may indicate the maximum disparity that may be determined in an image and thus indicate the minimum depth that may be determined using the active depth sensing system. With the unique portion of the distribution (referred to as the original distribution) repeating, the receiver 108 receives reflections for multiple instances of the original distribution (which was duplicated by the one or more DOEs before being emitted onto the scene 106). The following examples use a distribution of light points emitted by a VCSEL array (with the distribution in a rectangular shape) to depict aspects of the present disclosure. However, any suitable type of distribution, emitted light, and light source may be used.

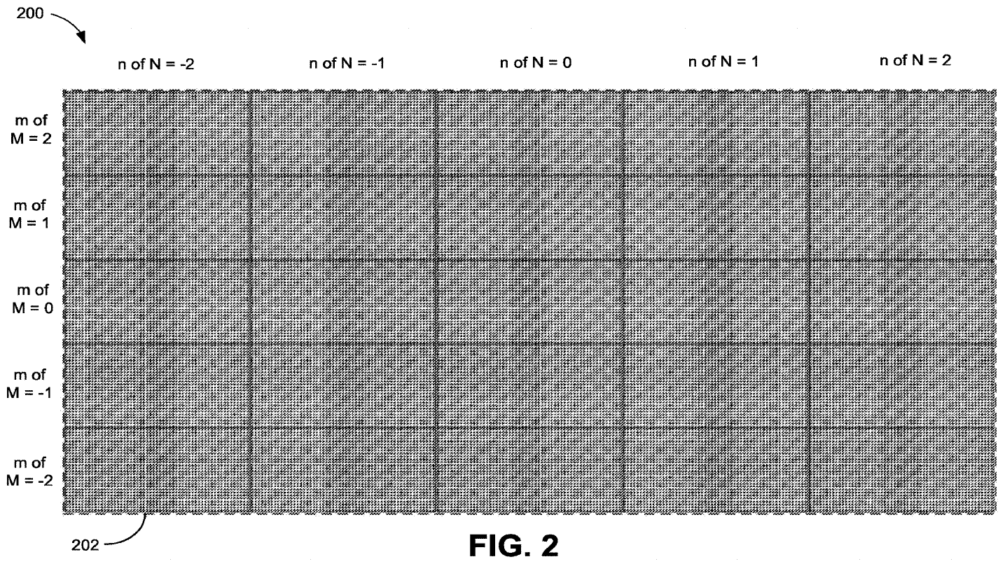

FIG. 2 shows a depiction of an example distribution 200 of light points projected onto a scene for active depth sensing. The dashed line 202 indicates the boundary of the projected distribution 200. The projected distribution 200 of light points includes a repetition of the original distribution for M rows and N columns. While the projected distribution 200 is illustrated as M=5 and N=5 (counted from −2 to 2 for both M and N), the number of repetitions (such as the number of rows and columns) may be any suitable number. Additionally, M and N may differ from one another or be the same. In some implementations, the original distribution may be projected at a center of the projected distribution, and the duplicates may be projected at other portions of the distribution. For example, in projected distribution 200, the original distribution may be at location 0×0 (row m in M=0 and column n in N=0). In this manner, the original distribution is at the center of the projected distribution 200. A location of a repeated distribution or the original distribution in the projected distribution 200 may be referred to as (m,n). In the above example, the original distribution is at (0,0). Duplicates of the original distribution may be at the other locations of the projected distribution (such as at (m,n) where at least one of m or n does not equal 0). For example, a duplicate of the original distribution at (0,0) may be located at (2,−1), (1,0), and other locations that are not (0,0). The original distribution may be referred to as the primitive array (or order 0 array or 0-order array), and the duplicated distributions may be referred to as diffracted arrays (or diffracted orders of the primitive array, non-0-order arrays, or order non-0 arrays). In some implementations, the projected distribution is 17×7 (M=17 and N=7), with the primitive array at (0,0) and the diffracted arrays at all other locations (with m of M from −8 to 8 and n of N from −3 to 3).

Since the projected distribution is not unique across its entirety, a reflection from an object of a portion of the distribution as captured in an image may be associated with a different array based on the location of the object. For example, a center of the distribution received at an image sensor may be associated with the primitive array, and a different portion of the distribution received at the image sensor may be associated with a diffracted array. The disparity associated with an image region including an identified codeword is based on the location of the codeword in the array (such as the difference between the location of the codeword in the array and the center of the image along a baseline). Since the distribution includes multiple instances of arrays, objects at different locations in a scene may be illuminated by different arrays of light points of the distribution. In this manner, the disparity may wrap around from a maximum disparity to a minimum disparity (such as from 192 image pixels to 0) and vice versa based on a location of an object changing in the scene.

Each array in the specific example may be referred to as a tile. In this manner, distribution 200 is 5 tiles×5 tiles. Each array or tile of the distribution 200 may be associated with a portion of an image including reflections of the distribution 200. For example, image sensor pixels at the top left corner of the image sensor 132 (FIG. 1) may capture reflections of array (2,−2) from the distribution 200. A device may include a mapping of locations in an image from the image sensor 132 to the specific array in the distribution. In this manner, the center of the array in the image and the location of a codeword in the array may be determined based on the mapping. In some implementations, the mapping indicates a location in each image corresponding to a center of each array.

Such mapping (or calculating a specific array in the distribution) is based on the projected distribution not including any distortions). However, duplicating the primitive array may cause an optical distortion in the projected distribution. For example, one or more DOEs in the emitter may cause the projected distribution to include a pincushion distortion. While a pincushion distortion is illustrated in the examples, any other types of distortion may be included in the projected distribution (such as a distortion caused by objects with different depths along an object surface). Therefore, while some examples may illustrate reducing effects of pincushion distortion, effects of other types of distortions may be reduced based on aspects of the present disclosure.

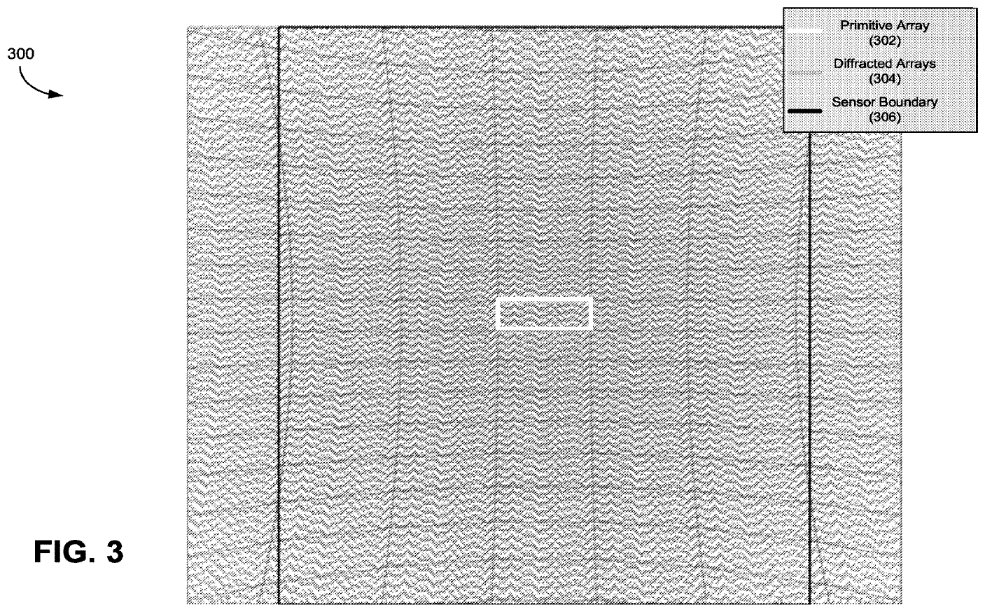

FIG. 3 shows a depiction of an example distribution 300 including a pincushion distortion. The distribution 300 is 17 tiles×7 tiles. The primitive array 302 (also referred to as the order 0 array) is at the center of the distribution 300 (location (0,0)). The diffracted arrays 304 surround the primitive array 302. One or more DOEs for duplicating the primitive array 302 for diffracted arrays 304 may cause a pincushion distortion in the projected distribution 300. As shown, diffracted arrays 304 may become more stretched and skewed as approaching the corners of the distribution 300 from the center of the distribution 300.

Sensor boundary line 306 indicates the boundary of the projected distribution 300 for which reflections of the distribution 300 are received by an image sensor. If the distribution 300 was not distorted, all of the diffracted arrays 304 would fit inside of the sensor boundary line 306. In this manner, reflections of each diffracted array 304 could be received by the image sensor. Further, each diffracted array 304 and the primitive array 302 could be associated with a location on the image sensor (and thus a location in the images captured by the image sensor).

A device performing conventional decoding of an image for active depth sensing may be unable to identify codewords in an image as a result of the stretching, skewing, or other distortions of the arrays that may cause the locations of light points to change. In particular, a device includes a mapping of codewords for the primitive array, and decoding is based on identifying a pattern of light points in the image as a codeword in the primitive array. In this manner, each diffracted array is assumed to be similar enough to the primitive array such that minor distortions in the distribution of light points (as captured in the image) does not negatively impact identification of the light points in an image. However, as shown in FIG. 3, the distortions of the diffracted arrays may be greater than a tolerance allowed for still identifying codewords using the primitive array.

To attempt to solve the above problem, a device may attempt to store mappings of the codewords of all diffracted arrays (and the primitive array) that takes into account the distortions of each array. The device, though, needs to identify which array corresponds to a distribution of light points identified in the image. For example, the device stores a tree structure or mapping of the spatial relationships between the arrays (with the root node of the tree structure corresponding to the primitive array and the diffracted arrays corresponding to children and further generational nodes from the root node), and the device performs a depth-first search through the tree structure to attempt to identify the corresponding diffracted array. As a result, the device recursively attempts to match an identified distribution of light points to a plurality of codewords for a plurality of different arrays until a best match is found. Such recursive methods and use of all array codeword mappings in the distribution increases the time and processing resources required to attempt to determine a depth value as compared to using the primitive array for all matching. The increase in time may be unsatisfactory to a user (such as for latency restricted applications, including VR or other real-time applications). Additionally, resource limited devices (such as mobile devices) may be unable to provide the increase in processing resources required. Therefore, devices use the primitive array mapping of codewords for identifying codewords throughout an image, which is more economical in time and processing resources for depth sensing than using multiple arrays' mappings.

The device may also assume which diffracted array includes the identified light points being matched based on the location being processed in the image. For example, a sampling mask may be applied to a pixel location in the image, and the pixel location is statically associated with a specific array. However, as a result of the distortions in the projection, a device may associate an identified codeword's location with an incorrect array in the projection (which would cause an error in the disparity). For example, as shown in FIG. 3, most of the diffracted arrays 304 with n=−3 or n=3 are outside of the image sensor boundary line 306. As a result, in one example, the device may incorrectly associate an identified codeword with an array (−7,−3) because the location is at a top left corner of the image (which is mapped to array (−7,−3) based on the pixel location in the image). However, the codeword may actually be part of array (−7,−2) or (−6,−2).

In addition, since a distortion of the projected distribution may occur during transmission (such as the distortion being caused by one or more DOEs of the transmitter), the amount of distortion in the reflections of the projection received by the image sensor may be based on the depths of objects from the image sensor. For example, as objects move away from the image sensor, stretching of the arrays in the reflections of the projected distribution from the objects as received by the image sensor may increase. As such, the distortion caused by the transmitter is not the same for every image, as the distortion of the projected distribution in the captured images may vary based on depths of objects in the scene. A device that uses the mapping of codewords from the primitive array for decoding an entire image may attempt to correct the distortion for images prior to decoding. In correcting the distortion before decoding, the device may determine a correction to be applied to an image (such as a mask to be applied to the image to correct the location of each light point in the image based on the distortion). However, correcting the distortion prior to decoding (such as determining the mask to be applied) requires being able to correctly identify each region of the projected distribution in an image. Correctly identifying each region may include identifying a plurality of codewords in each array of the distribution for an image. However, the distortion may cause the device to be unable to identify codewords or incorrectly identify the array associated with a codeword. As a result, the correction to be applied before decoding may not be determined. In addition, attempting to determine such a mask to reduce the distortion may be as time and resource intensive as using the mapping of codewords for all arrays and the mapping of arrays between one another during decoding, which may be unacceptable for latency restricted or resource restricted applications.

Alternatively, a device may attempt to compensate for the distortion after decoding. For example, a delta to a determined disparity or to a depth value (determined for an image region) that is caused by a known pincushion distortion may be subtracted from the disparity before determining a depth value. However, the pincushion distortion may change based on depths, and other distortions may exist based on objects in the scene. With the exact distortions being unknown, the device is unable to determine the delta in order to correct a disparity or a depth value. In addition, the distortions may cause some portions of a projection in the image to not be identified in order to determine a disparity or a depth value. Therefore, a problem with pre-decoding correction and a problem with post-decoding correction is that the distortion needs to be corrected first in order to successfully decode an image, but the image needs to be successfully decoded first in order to correct the distortion.

In some aspects of the present disclosure, a device is able to decode images for active depth sensing in the presence of distortion for the projection (such as a pincushion distortion or a distortion that may be caused by slanted or curved surfaces of objects in a scene). In some implementations, the device adjusts sampling one or more regions of an image to compensate for the distortion. With the device able to decode an image in the presence of distortion, the device may be able to determine correct depth values for objects in a scene without the need of attempting to correct a distortion pre or post-decoding.

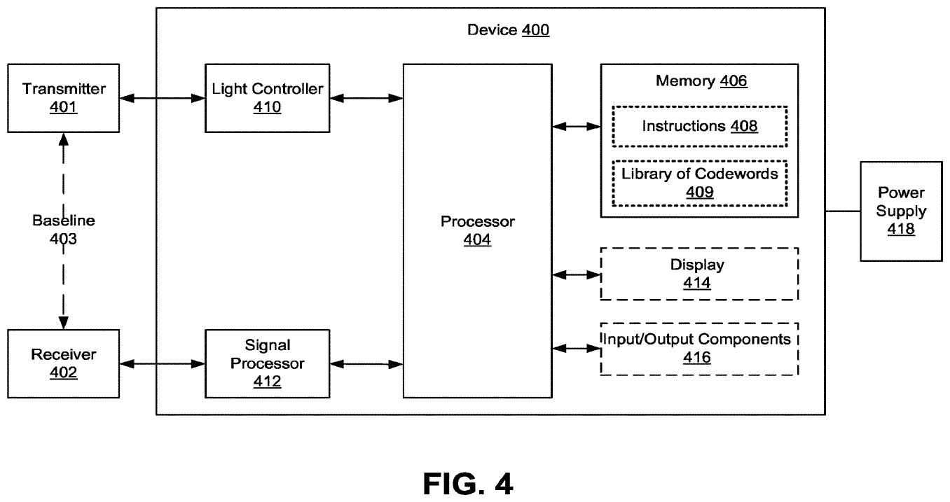

FIG. 4 shows a block diagram of an example device 400 for active depth sensing. The example device 400 may be configured to perform structured light depth sensing. The example device 400 may include or be coupled to a transmitter 401. The transmitter 401 may be similar to emitter 102 in FIG. 1. For example, the transmitter 401 is configured to project a distribution of light for structured light depth sensing. The example device 400 may also include or be coupled to a receiver 402 separated from the transmitter 401 by a baseline 403. The receiver 402 may be similar to receiver 108 in FIG. 1. For example, the receiver 402 includes an image sensor configured to receive IR light (or other frequency light) emitted by the transmitter 401 and reflected by one or more objects in a scene. The transmitter 401 and the receiver 402 may be part of an active depth sensing system (such as the system 100 in FIG. 1) controlled by a light controller 410 and/or a processor 404.

An image sensor configured to receive IR light may be referred to as an IR image sensor. In some implementations, an IR image sensor is configured to receive light in a range of frequencies greater than IR. For example, an image sensor not coupled to a color filter array may be capable of measuring light intensities for light from a large range of frequencies (such as both color frequencies and IR frequencies). In some other implementations, the IR image sensor is configured to receive light specific to IR light frequencies. For example, the IR image sensor may include or be coupled to a bandpass filter to filter light outside of a range of frequencies not associated with IR light. As used herein, IR light may include portions of the visible light spectrum and/or portions of the light spectrum that is not visible to the naked eye. In one example, IR light may include near infrared (NIR) light, which may or may not include light within the visible light spectrum, and/or IR light (such as far infrared (FIR) light) which is outside the visible light spectrum. The term IR light should not be limited to light having a specific wavelength in or near the wavelength range of IR light. Further, IR light is provided as an example emission for active depth sensing. In the following description, other suitable wavelengths of light may be captured by an image sensor or used for active depth sensing, and an IR image sensor or active depth sensing is not limited to IR light or a specific frequency of IR light.

The example device 400 also includes a processor 404, a memory 406 storing instructions 408 and a library of codewords 409, a light controller 410, and a signal processor 412. The device 400 may optionally include (or be coupled to) a display 414, a number of input/output (I/O) components 416, and a power supply 418. The device 400 may also include additional features or components not shown. For example, a wireless interface, which may include a number of transceivers and a baseband processor, may be included for a wireless communication device to perform wireless communications. In another example, the device 400 may include one or more cameras (such as a contact image sensor (CIS) camera or other suitable camera for capturing images using visible light).

The memory 406 may be a non-transient or non-transitory computer readable medium storing computer-executable instructions 408 to perform all or a portion of one or more operations described in this disclosure. If the light distribution projected by the transmitter 401 is divided into codewords, the memory 406 may store a library of codewords 409 for the light distribution. The library of codewords 409 may indicate what codewords exist in the distribution and the relative location between the codewords in the distribution. For example, since the distribution may include a repetition of a primitive array, the library of codewords 409 may indicate the codewords and arrangement of codewords in an array. The library of codewords 409 may also include a mapping of one or more image sensor locations to locations of arrays in the light distribution (such as locations of the diffracted arrays and the primitive array with reference to an image captured by the image sensor). The library of codewords 409 may thus be used in decoding an image from the receiver 402.

The processor 404 may include one or more suitable processors to perform aspects of the present disclosure for decoding an image for active depth sensing to account for optical distortion. In some aspects, the processor 404 may include one or more general purpose processors capable of executing scripts or instructions (such as instructions 408 stored within the memory 406) of one or more software programs or to otherwise cause the device 400 to perform any number of functions or operations. In additional or alternative aspects, the processor 404 may include integrated circuits or other hardware to cause the device 400 to perform functions or operations without the use of software. In some implementations, the processor 404 is configured to decode one or more regions of an image from the receiver 402 to determine one or more depth values. For example, the processor 404 may perform aspects of the disclosure to decode the image, accounting for optical distortion. The processor 404 may also be configured to provide instructions to the light controller 410 for controlling the transmitter 401.

The light controller 410 is configured to control operation of the transmitter 401. The light controller 410 may instruct the transmitter to be enabled or disabled based on whether the device 400 is in an active depth sensing mode. The light controller 410 may also instruct the transmitter 401 to adjust the intensity of the projected distribution (such as by adjusting the current to the VCSELs or other suitable light source of the transmitter). In some implementations, the light controller 410 include one or more suitable processors to execute programs or instructions (such as instructions 408 in memory 406). In additional or alternative aspects, the light controller 410 may include integrated circuits or other hardware to control the transmitter 401. The light controller 410 may be controlled by the processor 404. For example, the processor 404 may provide generic instructions to the light controller 410 regarding operation of the transmitter 401 (such as the transmitter 401 is to be projecting the distribution). The light controller 410 may convert the generic instructions to component specific instructions recognized by the transmitter 401 in order to control operation of the transmitter 401. While the light controller 410 is depicted as being separate from the processor 404, in some implementations, the light controller 410 may be included in the processor 404. For example, the light controller 410 may be embodied in a core of the processor 404. In another example, the light controller 410 may be embodied in software (such as in instructions 408) that when executed by the processor 404 cause the processor 404 to control operation of the transmitter 401.

The signal processor 412 may include one or more processors to process images captured by the receiver 402. For example, the signal processor 412 may include one or more image signal processors (ISPs) that are part of an image processing pipeline to apply one or more filters to an image from the receiver 402 before being decoded by the processor 404. Example filters that may be applied by the signal processor 412 may include a brightness uniformity correction filter, denoising filter, or other suitable image processing filters. In some aspects, the signal processor 412 may execute instructions from a memory (such as instructions 408 from the memory 406 or instructions stored in a separate memory coupled to the signal processor 412). In other aspects, the signal processor 412 may include integrated circuits or other specific hardware for operation. The signal processor 412 may alternatively or additionally include a combination of specific hardware and the ability to execute software instructions. While the signal processor 412 is depicted as processing an image from the receiver 402 before the processor 404 decodes the image, in some implementations, the processor 404 may receive the image from the receiver 402 (without the device including a signal processor 412 to further process the image). In some other implementations, the signal processor 412 may be configured to perform decoding of an image from the receiver 402. For example, the signal processor 412 may perform aspects of the disclosure for decoding the image.

A display 414 may include any suitable display or screen allowing for user interaction and/or to present items (such as a depth map, a preview image of the scene, and so on) for viewing by a user. In some aspects, the display 414 may be a touch-sensitive display. I/O components 416 may include any suitable mechanism, interface, or device to receive input (such as commands) from the user and to provide output to the user. For example, the I/O components 416 may include a graphical user interface (GUI), keyboard, mouse, microphone and speakers, squeezable bezel, or border of the device 400, physical buttons located on device 400, and so on.

While shown to be coupled to each other via the processor 404 in the example of FIG. 4, the processor 404, the memory 406, the light controller 410, the signal processor 412, the display 414, and the I/O components 416 may be coupled to one another in various arrangements. For example, the processor 404, the memory 406, the light controller 410, the signal processor 412, the display 414, and/or the I/O components 416 may be coupled to each other via one or more local buses (not shown for simplicity). While some components of the device 400 are shown, the device 400 may include other components that are not shown for clarity in describing aspects of the disclosure. For example, the device 400 may include an analog front end between the receiver 402 and the signal processor 412. The analog front end may convert analog signals for an image captured by the receiver 402 to an array of digital values that is the image. Conversely, some components of the device 400 are shown but are not required for performing aspects of the present disclosure. For example, the signal processor 412 may not be needed to process images from the receiver 402. In another example, the processor 404 and memory 406 may receive an image from a separate device including the transmitter 401 and the receiver 402. In this manner, the device 400 may not include the light controller 410, the transmitter 401, the receiver 402, or the signal processor 412. In a further example, the device 400 may include the receiver 402 but not the transmitter 401. Also, as noted above, the device 400 may not include a display 414 and/or I/O components 416. While the below examples of decoding an image for active depth sensing (such as structured light depth sensing) are described with reference to device 400, any suitable device may be used in performing aspects of the disclosure. As such, the present disclosure is not limited to a specific device configuration or configuration of components for performing aspects of the present disclosure.

The device 400 (such as the processor 404) may decode an image from the receiver 402, including sampling regions of the image, identifying portions of an array in the sampled regions of the image (such as identifying codewords), determining disparities based on the locations of the identified portions in the array, and determining depth values based on the determined disparities. Decoding a region of an image may be associated with a metric or function that indicates a confidence in a result determined during decoding (such as identified locations of light points, an identified portion of the projected distribution based on the arrangement of identified light points, a determined disparity, or a determined depth value). The metric or function indicating the confidence may be referred to as a confidence value or cost function. For example, in performing decoding, a confidence value may indicate a likelihood that an identified codeword for an image region is correct. Confidence values may be used by the device 400 to determine whether a depth value is to be determined for a region or whether a determined depth value is assumed to be correct. The confidence values may also be used to determine which sampling grid is to be applied to the region to identify one or more light points in the region.

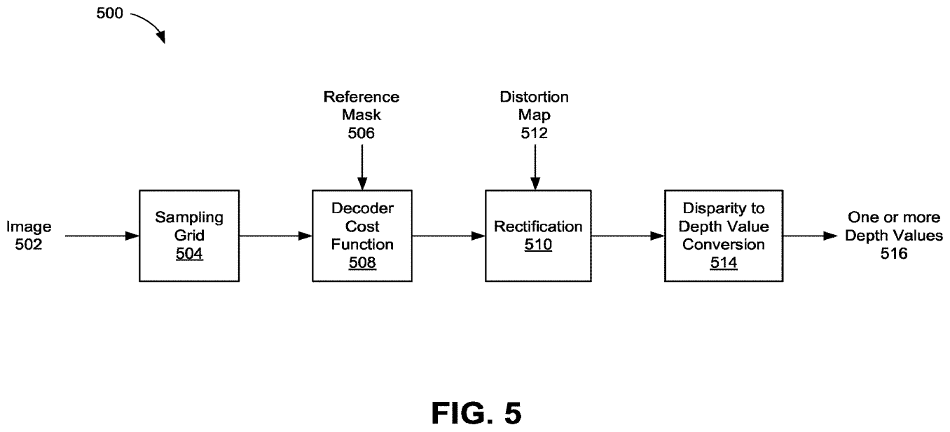

FIG. 5 shows a block diagram of an example decoding process 500 for active depth sensing. The decoding process 500 may be performed by the processor 404 (FIG. 4). In some other implementations, the decoding process 500 may be performed by the signal processor 412 or other suitable components of the device 400. As shown, the decoding process 500 does not require a recursion or other resource intensive flow of operations. The decoding process 500 may be a linear operation where operations are performed once (not recursively multiple times, as required in other possible solutions for accounting for distortion in the projection).

In the decoding process 500, a sampling grid phase 504 includes sampling the image 502 to generate image samples for analysis. Sampling may include identifying light points of the distribution in an image region. In some implementations, the device 400 (such as the processor 404) receives an image 502 for decoding for active depth sensing (such as from the receiver 402, from a memory, or from another device including an active depth sensing system). During the sampling grid phase 504, the device 400 samples a region of the image 502. A sampling grid is used to sample a region of image pixels from the image 502 to generate an image sample (with the image sample to be analyzed to attempt to identify a location in an array in order to determine a disparity for the image region). The sampling grid may be used to sample different regions of the image 502 to attempt to identify different arrangements of light points in an array (such as to attempt to identify a codeword in each image region of the image 502). For example, a sampling grid may be used to identify a location of a patch of the projected distribution. As used herein, a patch may refer to a P×Q portion of the distribution (where P indicates the number of rows of possible light points and Q indicates the number of columns of possible light points). For example, a sampling grid may be associated with a 4×4 portion or patch of the distribution, which may include 16 possible positions (4 rows*4 columns) for light points. In some implementations, the size of the sampling grid used for the image 502 may be associated with the size of the codewords for an array. For example, if an array is associated with 5×5 codewords, the sampling grid may be of a size associated with 5×5 codewords. However, the size of the sampling grid may be any suitable size for sampling.

The sampling grid may be of sufficient size such that an associated patch is unique in an array compared to all other similar size patches in the array. For example, a sampling grid is not associated with a size 1×1 patch or 2×1 patch because multiple instances of patches exist in an array. In the examples, the sampling grid is depicted and described as being associated with size 4×4 patches (with codewords being size 4×4). However, a sampling grid may be associated with any suitable size patch to uniquely identify patches in an array for decoding.

The transmitter 401 may be configured to project a static distribution of light points. For example, the light source of the transmitter 401 and the one or more DOEs may be fixed positionally within the transmitter 401 such that the projected distribution does not change. In this manner, the spacing between light points of the distribution from the light source is known (including the spacing between light points along the baseline, which may be referred to as a pitch). For example, the spacing (such as the pitch) between VCSELs in a VCSEL array is known. In the examples, the pitch between light points is assumed to be constant across an array without distortion for clarity in explaining aspects of the disclosure. However, in some implementations, the pitch may vary based on a location in the array (such as different portions of VCSELs of a VCSEL array having different spacings between VCSELs).

The sampling grid may be larger (in units of image pixels of the image 502) than a patch size of the distribution (such as a codeword size of an array) at projection by the transmitter 401. For example, a size 4×4 codeword may be associated with a sampling grid of a size greater than 4 image pixels×4 image pixels. Each light point of a distribution may be associated with a point spread function, and a light point spreads while travelling to an object in a scene and reflecting back to the receiver 402. As a result, multiple pixels of an image sensor may receive light associated with the light point. In addition, spacing between light points, cross talk between components, thermal noise, distortion of a light point in an optical path (such as perspective distortion), and scatter of a light point at an object in the scene may cause the light point to be received at multiple pixels of an image sensor of the receiver 402. In this manner, a sampling grid size (in terms of image pixels) to be applied to the image 502 may be based on the spacing between light points, a known distortion (such as a perspective distortion), and a baseline for the active depth sensing system.

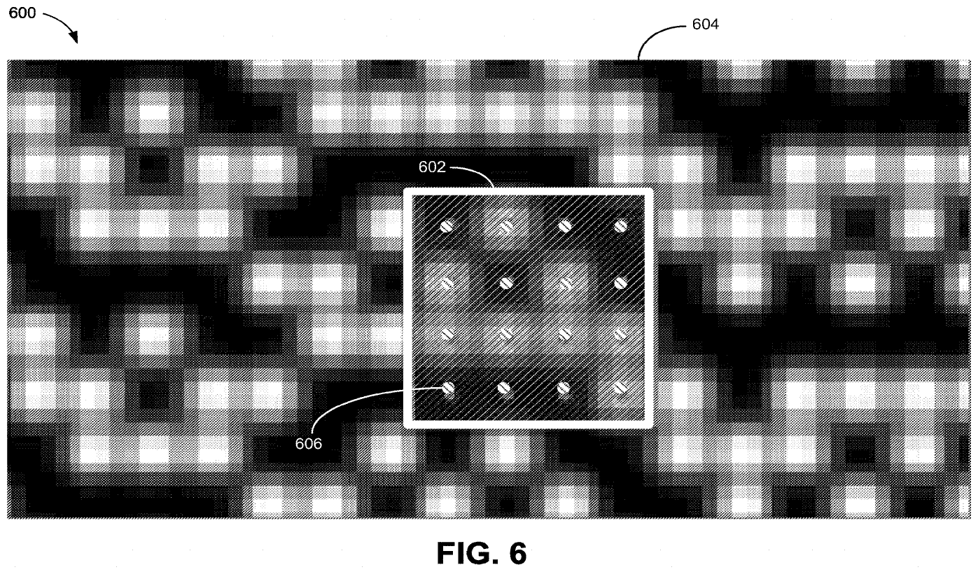

FIG. 6 shows a depiction 600 of an example sampling grid overlaid over a portion 604 of an image. As illustrated, the sampling grid includes a 4×4 arrangement of sampling points 606 that are used to sample 16 portions of the image to determine if light points of the distribution of light points within the portion 604 of the image exist at any locations of the 16 sample points 606. While a sampling point 606 is described as being used to sample a single image pixel, each sampling point 606 may be used to sample one image pixel or multiple image pixels (such as 2×1 or 2×2 groups of image pixels).

The portion 604 of the image is increased in size to illustrate individual pixels of the image. A lighter (whiter) image pixel indicates more light received at an associated image sensor pixel than an image sensor pixel associated with a darker (blacker) image pixel during image capture. For example, as described above with respect to FIG. 1, the emitter 102 can emit or project a distribution 104 of light points (which includes a codeword distribution) onto a scene. The light points can reflect off of one or more objects in the scene. The image sensor 132 can be configured to capture images including reflections of the light points emitted by the emitter 102. As indicated in the example portion 604 of the image, light from a single light point is received at multiple image sensor pixels. For example, light from a single light point may be received at a 3×3 group or a 4×4 group of pixels of the image sensor. In the example, the distribution of light points within the portion 604 of the image may have similar spacing between light points in a vertical direction and a horizontal direction. As shown in FIG. 6, the distribution does not include an optical distortion. In this manner, the spacing between light points in the portion 604 may be the same across the entire image.

With the sampling grid including 16 sampling points 606, generating an image sample using the sampling grid may include sampling a brightness value of the image pixels located at the sampling points 606. In this manner, an image sample may include a vector or other data structure of brightness values (with the positions in the vector corresponding to a position of the associated sampling point 606 with reference to the other sampling points 606). Each vector may be associated with a location in the image (such as a row and column location of a pixel in the image at the center of the sampling grid). The location may be included as an entry in the vector, the location may be indicated by a storage location in memory of the vector, or the location may be indicated in any other suitable manner. The sampling grid may thus be used to sample a region of the image, and such a vector may be an image sample for the image region.

The dimensions of the sampling grid may be based on the spacing (e.g., in terms of pixels) between the sampling points 606. In the example, each sampling point 606 includes 3 image pixels between itself and neighboring sampling points 606 (with the sampling points 606 in an isometric 4×4 arrangement). In this manner, each sampling point 606 may be associated with a 4×4 set of image pixels of the portion 604, and a sampling grid including a 4×4 isometric arrangement of sampling points 606 may be associated with a region of the image of size 16 image pixels×16 image pixels. As depicted, the sampling grid is used to sample region 602 (which may be of size 16×16 image pixels of the image), with sampling including sampling the 16 image pixels in the region 602 located at the 16 sampling points 606 of the sampling grid. In the example, the sampling grid may be referred to as having dimensions of 16 image pixels×16 image pixels. While quadrilateral shapes are illustrated and described in the examples of sampling grids, other shapes may be used for the sampling grid (such as hexagonal shapes). The shape may be based on the arrangement of the light points in the distribution.

In the example, the region 602 includes a 4×4 patch of the projected distribution. For example, the region 602 may include a 4×4 codeword of light points from an array. In some implementations, the device 400 may move the sampling grid across the image to generate image samples. For example, the device 400 may move the sampling grid pixel by pixel or region by region. As illustrated in FIG. 6, the sampling grid may be used to sample the region 602, and the image sample may be processed to attempt to identify a location in the projected distribution (such as to identify the 4×4 codeword). The sampling grid may then be used to sample a neighboring region, and that image sample may be processed to attempt to identify a location in the projected distribution (e.g., in the primitive, such as the primitive array 302 of FIG. 3) associated with the image sample. In one example, the device 400 may shift the sampling grid one or more image pixels in the image and generate another image sample for the new region. If shifting one image pixel, an image region may be sampled for almost every image pixel in the image.

In some implementations of sampling, the brightness values of the image pixels located at the sampling points 606 may be compared to a brightness threshold to determine if a light point of the distribution exists at the image pixel. For example, the device 400 may determine if the image pixel at a sampling point 606 has a brightness greater than a threshold. In some other implementations, the device 400 may determine if a brightness value of the image pixel at a sampling point 606 is greater than the brightness values of neighboring image pixels. In some further implementations, the device 400 may combine brightness values of the image pixels at and surrounding a sampling point 606 to determine if the combined value is greater than a threshold. In this manner, the sampling point 606 does not need to be located exactly at the center of the image pixels including brightness values for a light point in order to identify a light point (such as if an off center image pixel for the light point includes a brightness value greater than the brightness threshold). In the depicted example in FIG. 6, the sampling points 606 align with the locations of the light points in the region 602 such that 8 of the possible 16 locations in the region 602 include light points. In some implementations, the vector of brightness values generated from sampling the region 602 may instead include binary values indicating whether a light point does or does not exist at the location of the sampling point 606 (such as a 0 for no light point identified and a 1 for a light point identified). In some other implementations, the image sample may indicate in any suitable manner the arrangement of identified light points in sampling an image region. While FIG. 6 shows 16 sampling points, any suitable number of sampling points may exist. For example, each pixel in the region 602 may be sampled (such as each of the 16 pixels by 16 pixels) or any suitable subset of the pixels in the region may be sampled. As such, while the examples provided herein are described with reference to pixels located at sampling points 606 (or similar sampling points), any suitable pixels in the image region may be sampled.

Referring back to FIG. 5, during the decoder cost function phase 508, the device 400 attempts to identify a location in an array with the image sample generated during the sampling grid phase 504. For example, the device 400 attempts to identify a codeword in the array based on the arrangement of identified light points indicated by the image sample. The device 400 may also determine a confidence value associated with the identified location (which may refer to the identified codeword in the array). In some implementations, the device 400 may compare an image sample with a reference mask 506. A reference mask 506 may indicate an arrangement of light points for a patch of the array. For example, if the sampling grid includes a 4×4 arrangement of sampling points (such as in FIG. 6), the reference mask 506 may indicate an arrangement of light points for each 4×4 patch of the primitive array of the projected distribution. In some implementations, the reference mask 506 indicates a codeword in the array. The reference mask 506 may include a vector (such as a vector of binary values) or other suitable indication of light points at specific locations for a codeword. The device 400 may compare the generated image sample to one or more reference masks 506 for the primitive array to attempt to find a match. As used herein, a reference mask 506 may refer to a portion or region of an overall reference mask for the entire primitive array. For example, a reference mask 506 may be a 4×4 region (associated with a codeword of the primitive array) of the overall reference mask for the entire primitive array. While the examples herein may be described as using multiple reference masks for clarity in describing aspects of the disclosure, such examples may refer to using multiple, separate reference masks or may refer to using different portions of one overall reference mask for the primitive array.

If the reference mask 506 indicates locations of light points for a codeword, the library of codewords 409 may store a plurality of reference masks 506 to be used for comparison. The device 400 may identify the reference mask 506 indicating the arrangement of light points that best matches the arrangement of light points identified in the image sample. Since each reference mask 506 is associated with a location in the primitive array, the device 400 may identify a location in an array to be associated with the region of the image 502. Based on the location of the region in the image 502, the device 400 may also identify which array of the projected distribution is associated with the region (such as whether the region is associated with the primitive array or to which diffracted array the region is associated).

The device 400 may determine a confidence value or a cost function in a determined location in the projected distribution. For example, the device 400 may not accurately identify all light points in a region of the image during sampling. As a result, none of the reference masks 506 may match the image sample. However, the arrangement of light points that are identified may be sufficient to possibly match multiple reference masks 506 while determining the remaining reference masks 506 do not match. Some of the possibly matching reference masks 506 may also be removed from consideration based on reference masks 506 matched to other image samples. For example, a reference mask 506 matched to a neighboring image sample may be used to determine reference masks 506 associated with neighboring locations in the array (and thus may be more likely matching the current image sample). In another example, if a possible reference mask 506 was matched to a different image sample in a portion of the image 502 corresponding to the same array of the distribution, the reference mask 506 may be removed from or reduced in consideration as matching the current image sample. The confidence value may thus be based on the number of possibly matching reference masks 506, whether a reference mask 506 was previously matched, or reference masks matched for other image samples.

If the device 400 determines too many reference masks 506 with similar likelihoods of being the correct match, the device 400 may determine a low confidence value associated with the reference mask 506 (or the location associated with the reference mask 506) most likely to match. If more light points in the image sample are correctly identified, more points may exist to match a reference mask 506, fewer possible matching reference masks may exist, and the confidence value may increase. If less light points in the image sample are correctly identified, less points may exist to match a reference mask 506, more possible matching reference masks may exist, and the confidence value may decrease.

In some implementations, a confidence value may be determined by calculating the number of positions with matching light points or absence of light points identified in the image sample and in the reference mask 506. For example, for an image sample including a 4×4 patch of an array, the confidence value may be from 0-16 to indicate the number of positions that are correctly matched (such as whether a position in the array indicated by the reference mask 506 and a corresponding position in the image sample both include a light point or both do not include a light point). Such a confidence value may be a hamming distance, and in such an example, thresholding an image pixel's brightness value indicates whether a light point exists at the position in the image sample (if the brightness value of the pixel is greater than the threshold). In another example, only matching the locations including a light point are used to determine the confidence value. While the confidence value is described as being an integer, the confidence value may be any suitable indication of the confidence (such as a percentage, a decimal, a fraction, or any suitable number on a recognized scale to measure confidence). Another example of determining a confidence value or determining a match may include determining a cross-correlation between an image sample and the reference mask 506. However, any suitable means for determining a confidence value or determining a match may be used.

In some decoding implementations (such as identifying codewords in the primitive array based on block matching), the device 400 identifies a location in the array (such as a codeword in the array) by identifying a reference mask 506 from a plurality of reference masks 506 associated with the greatest confidence value. In some implementations, the identified location in the array may be determined by the device 400 to be correct if the confidence value is greater than a threshold. If all confidence values are less than the threshold, the device 400 may determine that a location cannot be determined or that a location in the array is not to be used to determine a disparity and a depth value for the region in the image.

In some other decoding implementations, a device may determine a signature for an image sample, and determining the signature may also determine a confidence value. For example, if the primitive array includes codewords of size 4×4, the sample region of the image may be of a size associated with a 4×4 codeword (such as 16 image pixels×16 image pixels as illustrated in FIG. 6). The light points of the primitive array may be arranged such that each codeword includes two light points per each column of four positions. In this manner, a column of the codeword may be associated with six different combinations of the two light points for the four positions. Each combination of the two light points is associated with a symbol used in generating a signature. In this manner, a codeword may be associated with a signature of four symbols (one symbol for each of the four columns), and the signature may have 1,296 (64) possible strings of four symbols.

Referring back to FIG. 6, the 16 sampling points 606 of the sampling grid are arranged in four columns (with each column having four sampling points 606) corresponding to 4×4 codewords (such as in the above example). As noted above, sampling may be used to indicate which points 606 of the sampling grid are associated with a light point from the projection for the image region 602. The device may also generate a signature for the image region based on the sampling. For example, the device determines a symbol for the samples from each column of sampling points. Continuing the above example of each 4×4 codeword including two light points per column, if the device identifies two light points in a column (such as for each column of sampling points 606 for the image region 602), the device may determine the symbol for the column (from the six possible symbols) corresponding to the positions of the two light points in the column. In this manner, the device may generate a signature of four symbols for the image region 602 (or any suitable region of the image).

If two light points are identified for a column, the symbol for the column is determined with a high confidence (such as above a threshold or even at 100 percent confidence since only one of the six combination of light points for the column matches). However, based on the positioning of the sampling grid or based on distortions in the projection or reflection of the light points, the device may identify more or less than two light points in the image region. If more or less than two light points are identified, more than one symbol or no symbols may correspond to the column (since no specific combination of two light points for the column for a codeword exclusively matches the combination of identified light points for the column). For example, if three light points are identified for a column of sampling points for an image region, three different symbols of the six possible symbols can correspond to the column. The device may attempt to determine the best matching symbol by any suitable means (such as based on differences between the brightness values to determine the two most likely light points to exist, based on a cross-correlation between samplings for the image and the current sampling values, based on machine learning or a neural network to determine the most suitable symbol, and so on). However, any matched symbol is not determined with 100 percent confidence. In a simplified example, if three symbols possibly correspond to the column based on identifying three light points, a determined symbol may be associated with a 50 percent confidence based on only three of the six symbols absolutely not corresponding to the column. However, a confidence may be based on other information, such as differences between the brightness values for the identified light points or other suitable measurements in determining a probability that the symbol corresponds to the column. In addition, if no symbol can be determined (such as based on identifying no light points in a column), a zero percent confidence may be determined. With each symbol that is determined (or a column for which no symbol is determined) being associated with a confidence, the four confidences may be used to determine a confidence value for the determined signature. For example, if the confidence of each column is a percentage less than or equal to 100 percent or a decimal or fraction less than or equal to one, the confidences may be multiplied together to determine the confidence value for the signature. In this manner, determining the signature may also include determining a confidence value for the signature for each image sample. In some implementations, the device determines multiple candidate signatures and confidence values associated with the different candidate signatures. The device may then select the candidate with the highest confidence value as the final signature associated with image region. While some examples for determining a signature and a confidence value corresponding to the signature are provided, any suitable means for determining a signature and confidence value may be performed.

To identify a codeword in the primitive array associated with an image region based on the signature, the device may match the signature to a signature or token string associated with a codeword. In one example, a reference mask 506 may be string of symbols associated with a codeword. An overall reference mask for the primitive array may be a concatenation of the symbol strings for the codewords in the primitive array to generate an overall string of symbols. In this manner, the overall reference mask may include multiple reference masks 506. In attempting to match a codeword, the device may compare the string of four symbols determined for the image region to the overall string of symbols for the primitive array, identify the string of four symbols in the overall string, and determine the location of the string of four symbols in the overall string of symbols for the primitive array. The location of the string of four symbols in the overall string of symbols may indicate the location of the codeword in the primitive array, and the location of the codeword in the primitive array may be used to determine a depth value (based on the disparity, as described herein). While some of the examples in the present disclosure describe block matching methods for identifying codewords from the primitive array for clarity in describing aspects of the present disclosure, matching codewords may be performed using any suitable means (such as methods that are signature-generation based for image regions). As such, the present disclosure is not limited to a specific implementation for identifying codewords or locations in a primitive array during processing.

While not shown in FIG. 5, phases 504 and 508 may be performed for multiple sampled regions of the image 502 to identify associated locations in the primitive array (such as associated codewords). After determining a location in the primitive array corresponding to a sampled image region, the device 400 may determine a corresponding location in a reference diffracted array (based on duplicated distributions of the primitive array, as shown in FIG. 3). After determining the location in the reference diffracted array, the device 400 may determine a disparity between the location in the reference diffracted array and a location of the sampled image region (e.g., a center of the sampled image region) along the baseline axis. The disparity is the spacing in the image 502 (along a baseline, such as baseline 112 in FIG. 1) between the location of the sampled image region and the associated location of the reference diffracted array. In some cases, the disparity may be measured in number of image pixels (or sub-pixels) along the baseline.

Aside from a pincushion distortion or distortions caused by objects in a scene or by the optical system (including one or more lenses, the DOE, and so on), the positioning of the transmitter 401 and the receiver 402 with reference to each other may introduce perspective distortion to the distribution as captured in the image 502. For example, the transmitter 401 and the receiver 402 may be in a toe-in configuration with reference to each other. Since the transmitter 401 projects a distribution of light onto a scene from a first perspective and the receiver 402 captures images of the scene from a second perspective (and the transmitter 401 and the receiver 402 are in a toe-in configuration), a parallax exists between the first perspective and the second perspective. The parallax causes a perspective distortion of the projected distribution as captured by the receiver 402 in the image 502. The perspective distortion may be corrected by adjusting determined disparities based on the perspective distortion (from a known parallax) at associated locations in the image 502.

During a rectification phase 510, the device 400 adjusts the one or more disparities to reduce the perspective distortion. Image rectification is the process of adjusting one or more images so that the perspectives of multiple images are a common perspective. Rectification for active depth sensing may be visualized as a similar process as image rectification (to adjust the perspective for the image 502 from the receiver's perspective to the transmitter's perspective). Since the parallax is known, the disparities may be perspective distorted in a pre-defined manner based on the locations in the image 502. Therefore, the transform for adjusting the disparities may be pre-defined based on image location since the parallax is known.

With the perspective distortion known for a pre-defined parallax, the device 400 may use a distortion map 512 to reduce the effects of perspective distortion. The distortion map 512 may include a plurality of values, with each value associated with a location in the image 502. In one example of applying the distortion map 512 to adjust a disparity, the disparity determined for an image region may be multiplied by a value in the distortion map corresponding the to the image region.

After the rectification phase 510 to reduce perspective or optical distortion, the device 400 may determine one or more depth values 516 during the disparity to depth value conversion phase 514. In some implementations, the conversion is a predefined mapping of number of image pixels to depth values based on the baseline 403.

Referring back to the rectification phase 510, as noted above, a distortion of the projected distribution may cause displacements of the light points located in the image 502. For example, a DOE diffracting a primitive array into diffracted arrays may cause a pincushion distortion in the distribution. The distortion map 512 is based on the projected distribution including no distortions other than the perspective distortion based on the parallax. In assuming a projected distribution (which includes a pincushion distortion or other type of distortion) is without other distortions, the rectification phase 510 may cause a different distortion of the distribution embodied in the disparities. For example, if a projected distribution from the transmitter 401 includes a pincushion distortion, and the image 502 including the projected distribution is rectified to adjust the perspective for the image 502, the distribution in the rectified image (to remove a perspective distortion) may appear to include a barrel distortion instead of a pincushion distortion.

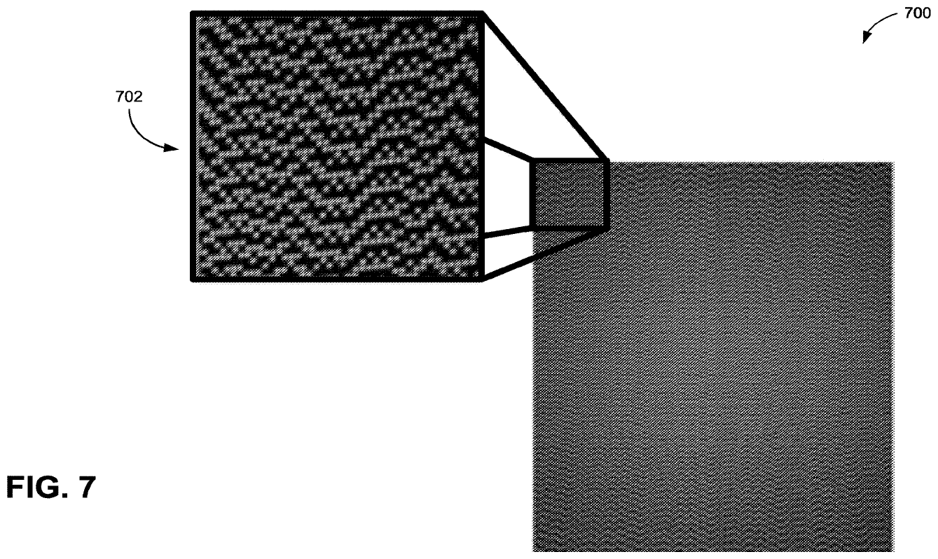

FIG. 7 shows a depiction of an example distribution 700 of light points in an example rectified image. In the example, the originally projected distribution includes a pincushion distortion (such as depicted in FIG. 3). After rectification of an image capturing the distribution with the pincushion distortion, the distribution 700 of light points includes a barrel distortion. Portion 702 of the distribution 700 illustrates the skew between light points caused by the pincushion distortion. In comparing the skew between light points in the top left corner of the distribution 700 and the skew between light points in the top left corner of the distribution 300 (FIG. 3), the skew among the light points differs between the distributions 700 and 300.

Since the distortion of the projected distribution from the transmitter 401 differs from the distortion of the distribution in a rectified image, the distortion caused by the transmitter 401 (such as the pincushion distortion) or caused by slanted objects in a scene may not be determined based on comparing a rectified image to the projected distribution of light points. Therefore, a distortion correction transform (to correct a pincushion distortion or other distortions) may not be determined or used for decoding. In some implementations, instead of attempting to remove optical distortion from an image 502 for decoding (or for post-decoding processing), the device 400 may use a decoding process that takes into account the effects of optical distortions.

Referring back to FIG. 6, the portion 604 of the image does not include a distortion of the projected distribution. Therefore, a fixed sampling grid may be sufficient for sampling the image. For example, as shown in FIG. 3, the distortion is less for the primitive array 302 than for the diffracted arrays 304. As such, an example sampling grid with an isotropic 4×4 pattern of sampling points 606 (FIG. 6) may be successfully used in sampling regions of an image including reflections of the primitive array 302 (and possibly neighboring diffracted arrays 304). However, sampling regions of an image including reflections of the diffracted arrays 304 further from the primitive array 302 (such as towards the edge of the distribution 300) may be difficult using the example sampling grid because of the stretching and skewing of the diffracted arrays 304 (and thus the arrangement of light points) caused by the pincushion distortion or slanted objects in the scene.

Regarding slanted objects, planes of objects in the scene for active depth sensing that are parallel to the plane defined by the image sensor and/or transmitter projection planes are best suited for sampling using the example sampling grid (such as the sampling grid in FIG. 6 with an isotropic pattern of sampling points 606). Without consideration to other optical distortions that may be present, the spacing between light points as captured in an image may be the same since the depths across the object are the same (and thus the light of light points from the transmitter, reflected by the object, and received at the receiver travel the same distance). For objects in the scene with differing depths from the receiver 402 at different points of the object's surface (which may be referred to as a slanted object), the spacing between light points as captured in an image may differ (since the paths of light points from the transmitter, as reflected by the object, and as received at the receiver are different distances). A fixed sampling grid with an isotropic pattern of locations (such as mask 506 in FIG. 5) may not be suited for decoding portions of a scene with slanted objects because of the differences in depths of different portions of the slanted object.

As a result of the distortions in the projected distribution, locations in an array (such as a codeword in the primitive array) may not be identified for some image regions during decoding. For example, a pincushion distortion of a projected distribution may cause the device 400 to be unable to identify codewords of the array in the corners of the image, and the device 400 may thus be unable to determine one or more depth values for regions in the image corners.

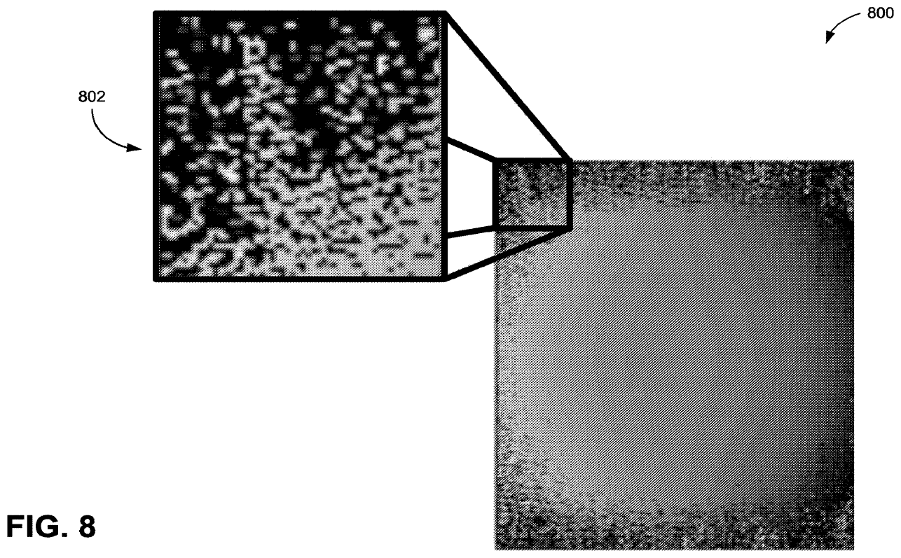

FIG. 8 shows an example depiction 800 of image regions for which locations in an array are identified. The black portions of the depiction 800 indicate regions in the image for which a location is not identified (such as a codeword in the primitive array not being identified) and thus a disparity (and a depth value) is not determined. Lighter portions of the depiction 800 indicate regions in the image for which a location is identified (such as a codeword in the primitive array being identified) and a disparity (and thus a depth value) is determined. In some implementations, the brightness of a region in the depiction 800 may be based on a confidence value in the identified location in the projected distribution for the region in the image. The depiction 800 may be based on the projected distribution including a pincushion distortion. For example, the depiction 800 may be associated with the distribution 300 of light points in FIG. 3. The portion 802 of the depiction 800 may thus be associated with a top left corner of the distribution 300 in the sensor boundary line 306). As a result of the skew of the light points in the top-left portion of the distribution 300, the device 400 may not identify a location or determine a disparity for a majority of regions in the top-left corner of the image (as depicted by the black areas in portion 802 in FIG. 8). As shown, the corners of the depiction 800 may indicate large areas of the image for which disparities are not determined by the device 400. As a result of fewer disparities being determined at the corners, fewer depth values may be determined for the corners of the image than for other portions of the image. If a depth map is generated, large portions of the corners would indicate a lack of depth values determined for the corners of the captured image.

For conventional decoding, the sampling grid is of fixed dimensions (such as 16 image pixels×16 image pixels in the example sampling grid in FIG. 6), and the sampling grid conventionally includes a fixed number and arrangement (including spacing) of sampling points for decoding (such as the isometric arrangement of sampling points 606 separated by three image pixels from each other in FIG. 6). As used for the examples below, a sampling grid associated with a P×Q patch of the distribution (such as having P×Q sampling points) may be referred to as a P×Q sampling grid or a size P×Q sampling grid with reference to the projected distribution.

As noted above, conventional decoding may be adjusted to reduce the effects of optical distortions on determining depth values. In some implementations, the device 400 may be configured to adjust the sampling grid for sampling an image during decoding. For example, the device 400 may adjust the arrangement of sampling points for a sampling grid (such as adjusting the spacing between sampling points). In addition or to the alternative, the device 400 may adjust the number of sampling points for a sampling grid. The device 400 may adjust the sampling grid to match the distortion for a distribution of light points captured in a region of the image being sampled. In some cases, a sampling grid out of multiple available sampling grids may be selected for use in sampling each region associated with (e.g., centered around) a pixel in the image (e.g., a first sampling grid can be selected for a first region in the image, a second sampling grid can be selected for a second region in the image, the first sampling grid can be selected for a third region in the image, etc.).

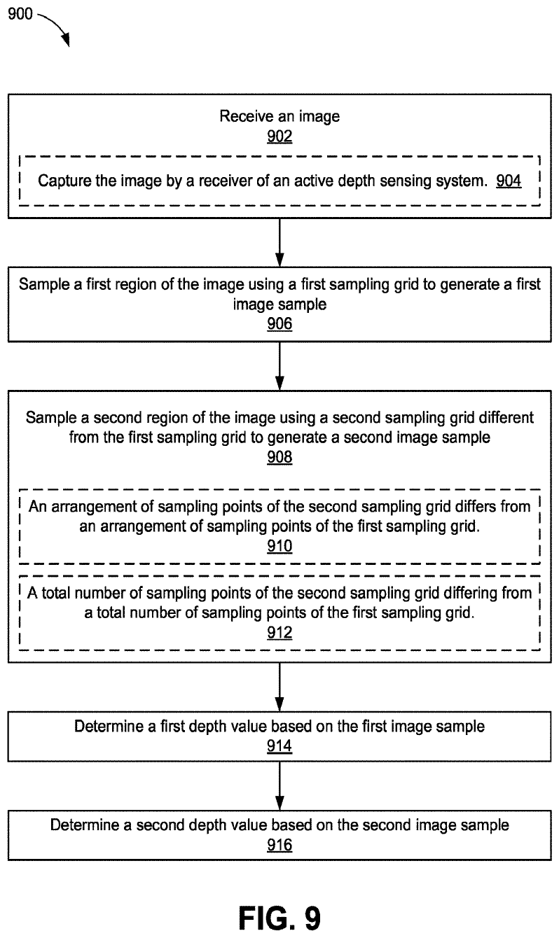

FIG. 9 shows an illustrative flow chart depicting an example process 900 of decoding an image for active depth sensing. The decoding process includes using differing masks to sample different regions of the image. In some implementations, different masks may refer to separate masks (such as separate signatures or blocks based on the decoding method for different codewords of a primitive array). In some other implementations, different masks may refer to different regions or portions of a single mask for an array (such as a single, overall signature or reference mask for the primitive array). At operation 902, the device 400 receives an image. In some implementations, the device 400 uses a receiver of an active depth sensing system (such as the receiver 402) to capture the image (corresponding to operation 904). In some other implementations, the device 400 (such as the processor 404) receives the image from a memory (such as memory 406) or from another device; in such implementations the device 400 may or may not include the receiver 402.

At operation 906, the device 400 samples a first region of the image using a first sampling grid to generate a first image sample. In some implementations, the process of sampling the first region is as described with reference to FIG. 6. At operation 908, the device 400 samples a second region of the image using a second sampling grid different from the first sampling grid to generate a second image sample. Similar to operation 906, the process of sampling the second region is as described with reference to FIG. 6.

In some implementations, the second sampling grid differing from the first sampling grid indicates that an arrangement of sampling points of the second sampling grid differs from an arrangement of sampling points of the first sampling grid (corresponding to operation 910 of FIG. 9). For example, the spacing (e.g., a number of pixels of the image sensor array) between sampling points of the second sampling grid may differ from the spacing between sampling points of the first sampling grid. In another example, a skew (e.g.; slant or orientation) of the sampling points of the second sampling grid may differ from a skew of the sampling points of the first sampling grid. In another example, the spacing and skew of the sampling points of the second sampling grid may differ from the spacing and skew of the sampling points of the first sampling grid.

In addition or to the alternative of the arrangements of sampling points differing, the second sampling grid differing from the first sampling grid can indicate that a total number of sampling points of the second sampling grid differs from a total number of sampling points of the first sampling grid (corresponding to operation 912). In one illustrative example, a first sampling grid may include 16 sampling points (such as a 4×4 arrangement of sampling points), and a second sampling grid may include 25 sampling points (such as a 5×5 arrangement of sampling points).

At operation 914, the device 400 may determine a first depth value based on the first image sample. At operation 916, the device 400 may determine a second depth value based on the second image sample. For example, referring back to FIG. 5, the device 400 may identify one or more light points of a distribution in a region of the image (such as during a sampling grid phase 504), identify a location in the primitive array based on the arrangement of identified light points in the region (such as during a decoder cost function phase 508), determine a disparity based on the identified location, adjust the disparity during a rectification phase 510, and determine a depth value based on the disparity during a disparity to depth conversion phase 514.

In some implementations, the device 400 may attempt to determine a depth value for each region of the image. For example, sampling may occur at a region associated with each image pixel. If a location in the array is accurately identified for the region (such as an identified codeword is associated with a confidence value greater than a threshold), a disparity and a depth value may be determined. If no location is accurately identified (such as each codeword in the array is associated with a confidence value less than the threshold), the device 400 may shift one image pixel (such as one pixel up, down, to the left, or to the right in the image) to sample the next region without generating a depth value for the previous region. While shifting one pixel is described in some examples, shifting or moving in the image for sampling different regions may be in any suitable manner (such as shifting multiple pixels in the image).

Referring back to operation 910 in FIG. 9, an arrangement of sampling points of the second sampling grid may differ from an arrangement of sampling points of the first sampling grid. In some implementations, the spacings between sampling points between the first sampling grid and the second sampling grid may differ. For example, the first sampling grid may be similar to the example sampling grid in FIG. 6 (with 3 image pixels between neighboring sampling points 606). The second sampling grid may include sampling points with more than 3 image pixels between neighboring points.

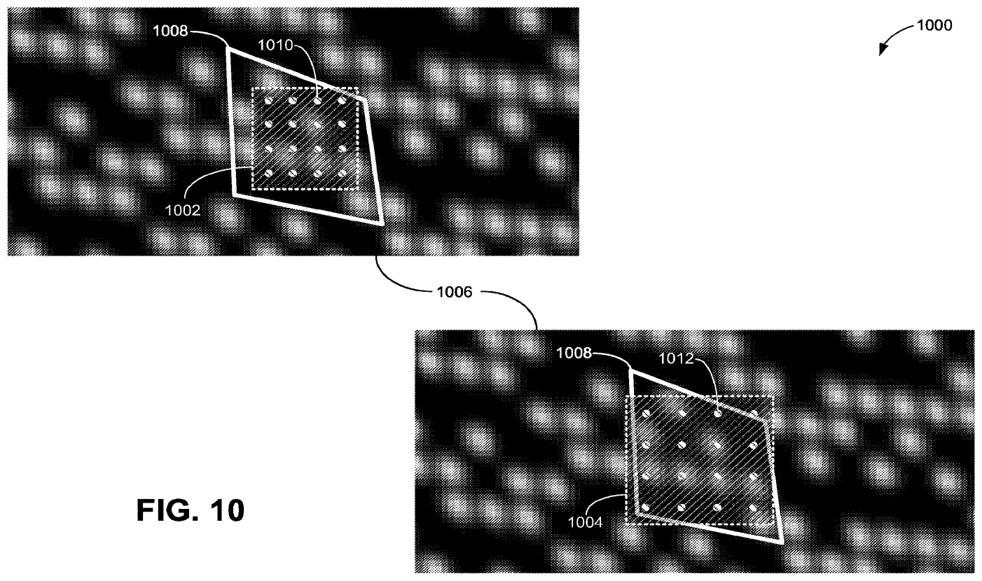

FIG. 10 shows an example depiction 1000 of a first sampling grid 1002 and a second sampling grid 1004 with different spacings between neighboring sampling points. As depicted for clarity in illustrating a difference in spacing between sampling points, the first sampling grid 1002 and the second sampling grid 1004 are applied to the same region 1008 of a portion 1006 of an image to sample the region 1008. In some implementations, though, the first sampling grid 1002 and the second sampling grid 1004 may also be applied to the same region of the image (e.g., to determine whether to use the first sampling grid 1002 or the second sampling grid 1004 for that region or to determine whether to use the image sample result from the first sampling grid 1002 or to use the image sample result from the second sampling grid 1004 for that region).

The first sampling grid 1002 includes a first spacing between neighboring sampling points 1010, and the second sampling grid 1004 includes a second spacing between neighboring sampling points 1012. The first spacing is smaller than the second spacing. In other words, the first spacing is associated with fewer image pixels between sampling points 1010 than the second spacing between sampling points 1012.

As shown, the spacing of light points in the region 1008 is greater than the spacing of sampling points 1010. However, the spacing of the light points in the region 1008 may be similar to the spacing of sampling points 1012. As a result, sampling using the second sampling grid 1004 may correctly identify more light points existing in the region 1008 than sampling using the first sampling grid 1002. In this manner, a second confidence value associated with the second sampling grid 1004 (e.g., based on applying the second sampling grid 1004 and then determining the second confidence value) may be greater than a first confidence value associated with the first sampling grid 1002 (e.g., based on applying the first sampling grid 1002 and then determining the first confidence value) for sampling the region 1008 (such as based on determining locations in an array associated with the image samples of the region 1008 generated using the first sampling grid 1002 and using the second sampling grid 1004).

The light points in the portion 1006 of the image are depicted as being skewed with reference to a horizontal and vertical axis. As such, the region 1008 including a 4×4 patch of the distribution is skewed (such as the region not being a square or rectangle in the example). The skew may be caused by a pincushion distortion in the projected distribution. The sampling grids 1002 and 1004 may not have the same skew of their sampling points as the skew of the region 1008. However, in some implementations, adjusting the spacing of sampling points (without skewing the arrangement of sampling points) may be sufficient for sampling an image region (such as the region 1008) for decoding.

As described above, a sampling point is not required to be located on a center of a light point in the image for the device 400 to identify a light point at the image pixel located at the sampling point. For example, the device 400 may identify a light point at the image pixel located at the sampling point if the brightness of the image pixel is greater than a threshold. As used herein, a brightness value may refer to any suitable measurement of the intensity of light as received at an image sensor pixel. Example brightness values may include values in lumens, luminances, white values defined for the image, red-green-blue (RGB) values defined for the image, or other suitable values.

In this manner, even with the region 1008 being skewed, the second sampling grid 1004 (having similar spacing of sampling points 1012 as the spacing of light points in the skewed region 1008) may be used to successfully identify a location in an array based on the identified light points at one or more sampling points 1012. Therefore, a disparity and a depth value may be determined for the region 1008 based on sampling using an unskewed sampling grid 1004. In some implementations, though, in addition or alternative to a difference in spacing between sampling points, a first sampling grid and a second sampling grid may differ with reference to a skew in the arrangement of the sampling points.

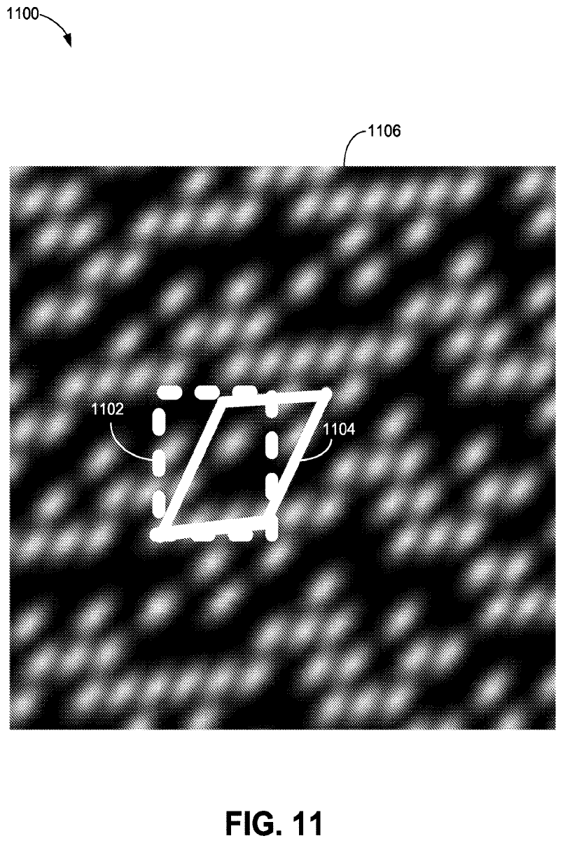

FIG. 11 shows an example depiction 1100 of a first sampling grid 1102 and a second sampling grid 1104 with different skews as applied in a portion 1106 of an image. While the sampling points are not shown for the sampling grids 1102 and 1104, the outlines of the sampling grids 1102 and 1104 are depicted to illustrate the skew in the arrangement of sampling points. As used herein, a skewing of a sampling grid may refer to any stretching, warping, or any other adjustment of the location of the sampling points so that the arrangement of the sampling points between sampling grids differs (other than a change in spacing of sampling points). For example, the arrangement of the sampling points for the first sampling grid 1102 may be rectangular, and the arrangement of the sampling points of the second sampling grid 1104 may be in the shape of a parallelogram, a trapezoid, or other suitable quadrilateral shape. In some implementations, the skewing may cause a change in the number of sides of the shape of the grid, curvature of the sides, or any other suitable changes to the arrangement of the sampling points. A sampling grid with a similar skew of sampling points as the skew of light points in a region of the image may be better suited for use in sampling the region than other sampling grids having different skews. For example, the second sampling grid 1104 may be better suited to be used for sampling regions in the portion 1106 than the first sampling grid 1102. As used herein, being better suited may refer to sampling using the better suited sampling grid causing higher confidence values to be determined than if using other sampling grids.

Referring back to operation 912 in FIG. 9, in addition or alternative to an arrangement of sampling points of a second sampling grid differing from an arrangement of sampling points of a first sampling grid, a total number of sampling points of the second sampling grid may differ from a total number of sampling points of the first sampling grid. For example, the first sampling grid may include 16 sampling points (such as a 4×4 isometric arrangement of the sampling points, such as in the sampling grid in FIG. 6 or the sampling grids 1002 or 1004 in FIG. 10). The second sampling grid may include a total number of sampling points greater than or less than 16. For example, the second sampling grid may include 20 sampling points (such as in a 4×5 arrangement or a 5×4 arrangement), 25 sampling points (such as in a 5×5 arrangement), or any other suitable number of sampling points.

The device 400 may sample a same region multiple times using different sampling grids to generate image samples for the region. The image samples may be used to attempt to identify a location in an array (such as identifying a codeword based on matching a reference mask 506 (FIG. 5)), and a confidence value may be determined for each sampling grid used for the image region. For example, the device 400 may apply a sampling grid to an image region and can then compute a confidence value for the sampling grid. In some implementations, block matching methods may be used to determine a codeword for an image region and/or a confidence value associated with the codeword for the image region. In some other implementations, signature generation methods may be used to determine a codeword and/or a confidence value associated with the codeword for the image region (as described above with reference to FIG. 5). For example, a signature may be determined using each sampling grid, and each signature may be associated with a confidence value. The highest confidence value indicates the sampling grid to be used for sampling the region to attempt to determine a depth value. The locations of light points in an image may depend on the location of the light points in a projected distribution of light points, the distortion of the projected distribution, and the depths of objects in a scene reflecting the light points from the projected distribution. Therefore, different sampling grids may be associated with varying confidence values based on a location of an image region in the image. In this manner, different sampling grids may be used to sample different regions of an image during decoding to determine depth values from the image.

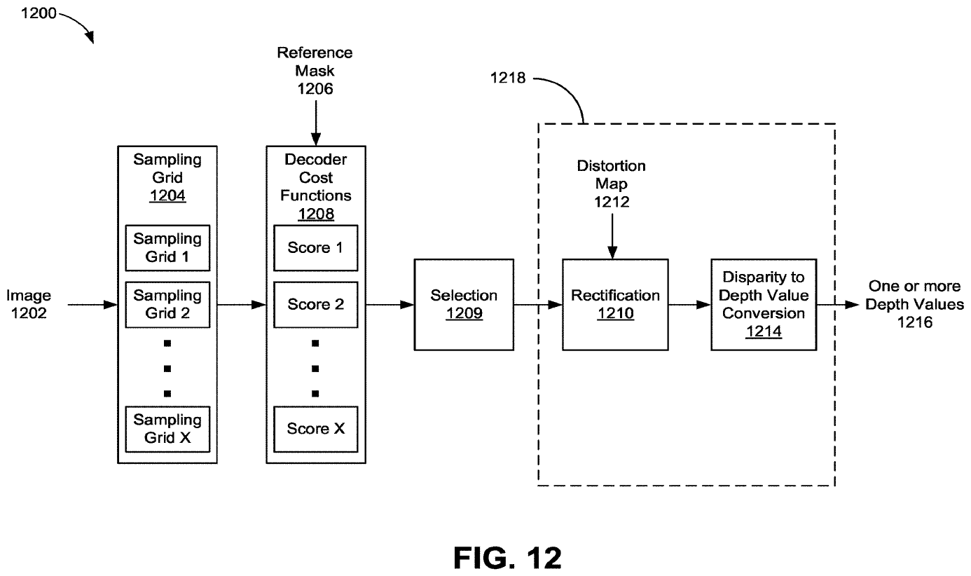

FIG. 12 shows a block diagram of an example decoding process 1200 using different sampling grids applied to an image captured by an image sensor or receiver (e.g., the receiver 402 of FIG. 4). During a sampling grid phase 1204, the device 400 may sample one or more regions of a received image 1202 using multiple sampling grids 1 through X (where X is an integer greater than 1). In some implementations, the device 400 may store the sampling grids 1 through X to be used for sampling during decoding. In some other implementations, the device 400 may include one or more template sampling grids (such as a template mapping of an arrangement of sampling points for a portion of an image being sampled). The template sampling grids may be adjusted to generate one or more of the different sampling grids 1 through X to be used for sampling during decoding. While some examples of persisting or generating the sampling grids or described, the sampling grids may be generated or persisted in any suitable manner so that they may be used for sampling one or more regions of the image 1202 during the decoding process 1200. While some examples may be described with reference to X=2, any suitable number of sampling grids may be used during the sampling grid phase 1204. The number of sampling grids may be determined to balance increasing accuracy in sampling (by having more sampling grids) with reducing processing cost in time and computing resources (by having less sampling grids). Each sampling grid differs from the other sampling grids used in sampling an image region. For example, each sampling grid may have a unique combination of an arrangement of sampling points (e.g., spacing, skew, etc.) and/or a total number of sampling points. For instance, in some implementations, the sampling grids differ from one another based on unique spacings between sampling points.

In one example of unique sampling grids for decoding, the sampling grids differ from each other based exclusively on spacing of sampling points, and the range in spacing is from 4 image pixels to 6 image pixels. In this specific example, the number of unique sampling grids may be 3 unique sampling grids to be used for sampling.

In the above specific example of 3 unique sampling grids, a pincushion distortion and a maximum disparity that may be determined based on a size of an array along a baseline of the distribution may indicate a minimum number of unique spacings that may be beneficial during sampling. The example implementation of 3 unique sampling grids may be based on one or more constraints (or similar constraints) for the example active depth sensing system in the specific example. In one illustrative example, a constraint is that there exist 48 locations for light points along a baseline of an array of the projected distribution. Another example constraint is that the pitch of locations along the baseline (with reference to the image) is 4 image pixels. With the number of locations in the array along the baseline being 48 and the pitch being 4 image pixels, the maximum measurable disparity is 192 image pixels (48×4). The pitch between locations in the array increases when moving along the baseline from the primitive array at the center of the distribution to the diffracted arrays at the edge of the example distribution. As a result, the spacing of possible locations of light points increases for diffracted arrays towards the edge of the distribution (which may affect the disparity if calculated based on an undistorted distribution). However, a maximum disparity of less than 600 image pixels may be sufficient based on the specific pincushion distortion and the intended range of depths for the active depth sensing system.

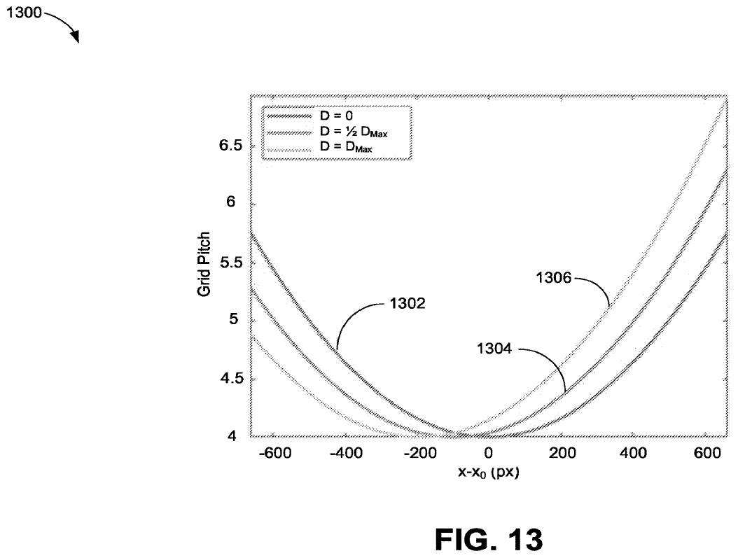

FIG. 13 shows an example graph 1300 depicting a relationship between a theoretical spacing between sampling points of a sampling grid to a disparity measurement for accurately sampling a region of an image. The graph 1300 shows an example depiction of a theoretical spacing of sampling points along a baseline for a sampling grid (pitch of the sampling grid) in order to accurately sample a region of the image including a patch of the distribution having a pincushion distortion. “Accurately sampling” the region may refer to properly identifying all light points in the region of the image. The vertex of the parabola 1302 indicates a measured disparity (D) of 0 based on a maximum depth (such as a depth approaching infinity) for a pitch of the distribution being 4 and the pitch of the sampling grid being 4. The vertex of the parabola 1304 indicates a measured disparity (D) of 96 pixels based on a depth halfway between the maximum depth and the depth associated with the maximum disparity that may be measured (which may be referred to as a minimum depth). The vertex of the parabola 1306 indicates a measured disparity (D) of 192 pixels based on the minimum depth. The minimum depth may be based on the size of the baseline and the size of the array along the baseline.

With no distortion and the pitch of the distribution being 4 image pixels, a similar pitch of sampling points in the grid sampling (4 image pixels) is preferred. This is shown by the vertices of the parabolas 1302-1306 for different depths. As the depth decreases, the disparity increases (shown by parabola 1304 to the left of parabola 1302 and parabola 1306 to the left of parabola 1304). While some image regions may be associated with an optimum grid pitch that is not an integer, the grid pitch for a sampling grid is an integer. However, tolerance based on light points existing over multiple image pixels allow for a closest integer for the grid pitch to be used for the sampling grid. In this manner, for the range of depths, the preferred pitch between sampling points (which may also be referred to as a grid pitch) may be an integer bounded by the parabola 1302 and the parabola 1306. As shown, a grid pitch of 4 image pixels to 6 image pixels may be sufficient for accurately decoding each region of an image.

While the above examples describe use of isotropic sampling grids (with the same number of columns as the number of rows of sampling points), in some implementations, the device 400 performing the decoding process (such as decoding process 1200 in FIG. 12) may also use anisotropic sampling grids. For example, the plurality of sampling grids to be used may include an arrangement of 4×4 sampling points, 4×5 sampling points, 5×6 sampling points, and so on. In another example, the plurality of sampling grid to be used may include an arrangement of 4×4 sampling points with different spacing in the horizontal direction and the vertical direction between sampling points (such as 4 pixels between points in the vertical direction and 5 pixels in the horizontal direction between points, 5 pixels between points in the vertical direction and 6 pixels in the horizontal direction between points, 5 pixels between points in the vertical direction and 4 pixels in the horizontal direction between points, and so on). In addition or to the alternative, while the examples describe the arrangement of sampling points as rectangular or square for a sampling grid, the arrangement may be skewed for one or more sampling grids (such as described above with reference to FIG. 11). As noted above, the number of sampling grids to be used may be based on balancing accuracy with performance.

While some examples describe uniqueness of a sampling grid based exclusively on spacing between sampling points, in some other implementations, the sampling grids differ from one another based on a unique combination of spacing between sampling points and a skew of the sampling points. However, any suitable attribute to make each sampling grid unique may be used.

Referring back to FIG. 12, sampling a region of the image (during the sampling grid phase 1204) using any of the sampling grids 1 through X may be performed by the device 400 similar to as described above with reference to the sampling grid phase 504 in FIG. 5. The sampling grid phase 1204 in FIG. 12 may differ from the sampling grid phase 504 in FIG. 5 in that multiple image samples 1 through X may be generated for an image region based on sampling the region X times using the different sampling grids (instead of one time as in the sampling grid phase 504 in FIG. 5). As noted with reference to FIG. 5, generating an image sample may include identifying light points in the image region at the location of sampling points in the sampling grid (or using any other suitable means of sampling).

In one example of two sampling grids used for sampling (such as X being equal to or greater than 2), a first sampling grid may be used for determining a depth value for a first region of the image 1202, and a second sampling grid may be used for determining a depth value for a second region of the image 1202. As described in more detail here, the first sampling grid used for the first region can be determined based on a confidence value determined for the first sampling grid being greater than confidence values determined for other sampling grids when applied to the first region. Similarly, the second sampling grid used for the second region can be determined based on a confidence value determined for the second sampling grid being greater than confidence values determined for other sampling grids when applied to the second region. In this manner, a device 400 may sample the first region of the image using the first sampling grid (e.g., to generate a first image sample), sample the second region of the image using the second sampling grid different from the first sampling grid (e.g., to generate a second image sample). The device 400 can then determine the first depth value based on the first image sample, and can determine the second depth value based on the second image sample. For example, to determine the first depth value, the device 400 may identify a first location in an array (e.g., a primitive array or diffracted array, such as primitive array 302 or one of the diffracted arrays 304 in FIG. 3) based on the first image sample and determine a first disparity based on the first location. The first disparity may then be converted to the first depth value (as described herein).

Both sampling grids may be used during the sampling grid phase 1204 for both the first region and the second region of the image 1202. In this manner, the device 400 may also sample the first region of the image using the second sampling grid (e.g., to generate a third image sample). In some cases, the device 400 can compare the first sampling grid and the second sampling grid. The device 400 can select the first sampling grid to be used for determining the first depth value based on the comparison. In some cases, the device 400 can compare the first image sample and the third image sample, and can select the first image sample to be used for determining the first depth value based on the comparison. During the decoder cost functions phase 1208, the device 400 may determine confidence values associated with the sampling grids (e.g., sampling grid 1, sampling grid 2, through sampling grid X). The confidence values are illustrated in FIG. 12 as score 1 for the confidence value associated with sampling grid 1, score 2 for the confidence value associated with sampling grid 2, and so on to score X for the confidence value associated with sampling grid X for the image region. In some implementations, comparing the first sampling grid and the second sampling grid, or comparing the first image sample and the third image sample, may include comparing confidence values indicating a likelihood of success in identifying light points in the image region or in identifying a location in the array (e.g., the primitive array). In some cases, the device 400 may determine a confidence value for each sampling grid (e.g., a first confidence value for sampling grid 1, a second confidence value for sampling grid 2, and a first confidence value for sampling grid X). In some cases, the device 400 may determine a confidence value for each image sample generated using each sampling grid (e.g., a first confidence value for a first image sample generated using sampling grid 1, a second confidence value for a second image sample generated using sampling grid 2, and a first confidence value for a third image sample generated using sampling grid X).

In some implementations during the decoder cost functions phase 1208 (such as if using block matching methods to determine a codeword), the device 400 may attempt to identify, for each image sample, a location in an array of the distribution based on the arrangement of identified light points. In some implementations, identifying a location in the array (e.g., the primitive array) includes identifying a patch in the array (such as identifying a codeword in the primitive array 302). In some other implementations, the device 400 may generate a signature for each image sample (such as described above). In some cases, the signature for each image sample is associated with a confidence value. In such implementations, identifying a location in the array may include identifying a string of symbols for the primitive array that matches the generated signature for one or the image samples (such as for the image sample associated with the highest confidence value for the image region). In some implementations, each identified location for each image sample is associated with a confidence value (e.g., the confidence value associated with a corresponding sampling grid, image sample, and/or signature). In some cases, the device 400 may determine a confidence value associated with each identified location for each image sample.

Identifying a location in the array and generating a confidence value (e.g., a confidence value for each image sample or sampling grid) for an image region (during the decoder cost functions phase 1208) may be similar to that as described for the decoder cost function phase 508 in FIG. 5. For example, one or more reference masks 1206 for the distribution may be compared to an image sample to attempt to match a reference mask 1206 to the image sample. If the reference mask 1206 indicates a codeword of the array, the device 400 determines the location of the codeword in the image (which may be used to determine the disparity from a location of the center of the associated array in the image). The decoder cost functions phase 1208 in FIG. 12 may differ from the decoder cost function phase 508 in FIG. 5 in that multiple confidence values may be determined (such as one confidence value for each of image samples generating using sampling grids 1 through X for the region, one confidence value for each of the sampling grids 1 through X as applied to the region, etc.) instead of one confidence value being determined for the region during the decoder cost function phase 508 in FIG. 5.

In some other implementations, a confidence value is determined when determining each signature for each sampling grid for the image region. The signature with the highest confidence value may be selected, and the selected signature is used to attempt to determine the codeword or location in the array (such as described above with reference to FIG. 5).

In the above example of comparing the first sampling grid and the second sampling grid, the device 400 can determine a first confidence value associated with the first sampling grid and determine a second confidence value associated with the second sampling grid. Based on the first confidence value being greater than the second confidence value, the device 400 can select the first sampling grid for use in determining a depth value for the first region. For example, the device 400 can compare the first sampling grid and the second sampling grid at least in part by comparing the first confidence value and the second confidence value. Based on the comparison, the device 400 can determine that the first confidence value is greater than the second confidence value.

In the above example of comparing the first image sample and the third image sample, the device 400 can determine a first confidence value associated with the first sampling grid for the first region based on the first image sample and can determine a second confidence value associated with the second sampling grid for the first region based on the third image sample. The device 400 can compare the first confidence value and the second confidence value (such as described above). The device 400 can select the first image sample based on the first confidence value being greater than the second confidence value.

The device 400 may thus generate multiple image samples and associated confidence values for an image region during the decoder cost functions phase 1208 or the sampling grid phase 1204. During the selection phase 1209, the device 400 may select the sampling grid and/or the image sample to be used for determining a disparity (and thus a depth value) for the region. For example, the device 400 may select one of multiple identified locations in the array (e.g., the primitive array) based on the confidence values (such as the location associated with the greatest confidence value) or may select the signature with the highest confidence value to determine the location in the array. For instance, the sampling mask associated with the greatest confidence value may be used for determining the disparity for the region during decoding. Since confidence values may depend on different factors (such as depths of objects, slanted objects, or distortions in the distribution), a first sampling grid may be selected for a first region of the image 1202 and a second sampling grid may be selected for a second region of the image 1202.

Similar to as described above with reference to FIG. 5, while not shown, the decoding process 1200 may include performing the sampling grid phase 1204, the decoder cost functions phase 1208 and the selection phase 1209 for multiple regions of the image 1202. For example, the device 400 may shift sampling (using the multiple sampling masks) one or more pixels in the image 1202. In some implementations, sampling a unique region of the image 1202 may be performed for each image pixel of the image 1202 (with a new region being a shift of one image pixel in a direction from the previous region). While the phases 1204, 1208, and 1209 are described as being performed recursively for multiple regions of the image 1202, in some implementations, the phases 1204, 1208, and 1209 may be performed concurrently for at least two or more regions of the image 1202. Therefore, the order of phases may not necessarily be required as depicted in the figures or examples.

After selecting the location in the array of the projected distribution (during selection phase 1209), the device 400 may determine a disparity associated with the region. The device 400 may then determine a depth value of the one or more depth values 1216 based on the disparity (such as during the disparity to depth value conversion phase 1214). In some implementations, the portion 1218 of the decoding process 1200 is the same as in the decoding process 500 in FIG. 5. For example, the rectification phase 1210 may be the same as the rectification phase 510 in FIG. 5, the distortion map 1212 may be the same as the distortion map 512 in FIG. 5, and the disparity to depth value conversion phase 1214 may be the same as the disparity to depth value conversion phase 514 in FIG. 5. In this manner, the decoding process 1200 may differ from the decoding process 500 in FIG. 5 at the sampling grid phase 1204, the decoder cost functions phase 1208, and a new selection phase 1209. In some implementations, the one or more depth values 1216 may be used to generate a depth map including the one or more depth values 1216. For example, a first depth value for a first region and a second depth values for a second region is included in the depth map, and the depth map indicates one or more depths of one or more objects in the scene. The depth map may be displayed on the display 414 for the user, may be used for one or more depth sensing applications (such as facial recognition for a display unlock or security applications, obstacle recognition or avoidance, range finding or distance measurement, or augmented reality applications), or may be used for other suitable applications.

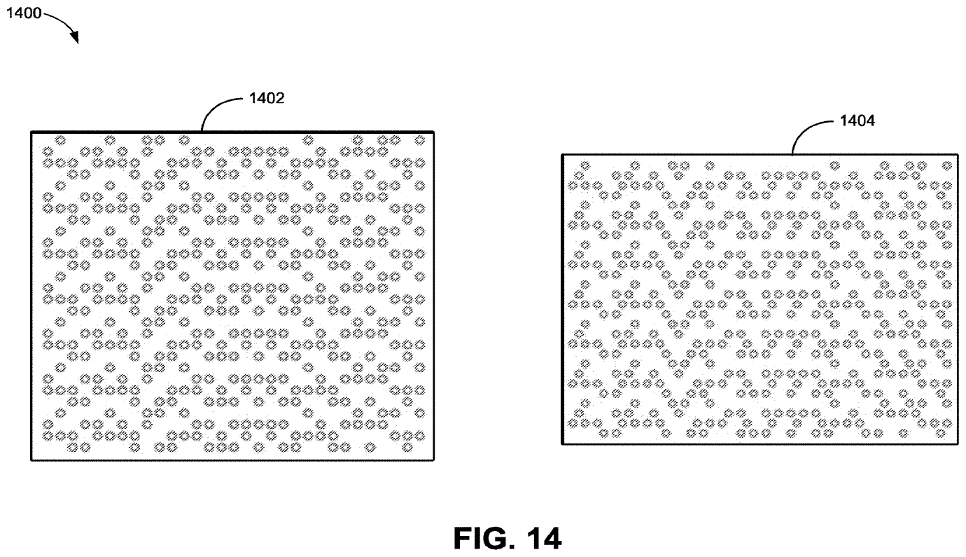

While the above examples of a projected distribution are described with reference to a square lattice of light points, the projected distribution may be any suitable distribution. For example, the shapes of light in the distribution may be other than points, such as arcs, straight lines, curved lines, squares, and so on. In another example, the lattice of light points may not be a square lattice. For example, the distribution of light may include a hexagonal lattice of light points. FIG. 14 shows an example depiction 1400 of a square lattice of light points 1402 and a hexagonal lattice of light points 1404 as a comparison. An active depth sensing system may use a projected distribution with a hexagonal lattice of light points to reduce the size of the primitive array while including the same number of locations for light points in the array. In this manner, smaller elements may be used (such as a smaller image sensor and a smaller DOE), which may reduce size of the active depth sensing system or the cost to produce the active depth sensing system. In this manner, the sampling grids may be based on the distribution including a hexagonal lattice of light points instead of a square (or rectangular) lattice of light points.

As noted above, determining a depth value based on an identified location in an array includes determining a disparity and converting the disparity to a depth value. In identifying the location, the device 400 may identify the location of a patch (such as a codeword) in a primitive array with the location of the image region. The location in the image region may be coordinates (such as (x,y) coordinates) of the region in the image associated with the identified codeword. If a baseline axis is the x axis, a disparity may be x_{location}−x_{center} where x_{location} is the x coordinate of the location of the codeword in the image and x_{center} is an x coordinate of the location of a center of the associated array in the distribution.

However, a DOE may duplicate the primitive array along the baseline so that the projected distribution includes a sequence of diffracted arrays centered by the primitive array. For example, 3 diffracted arrays may exist on both sides of the primitive array along the baseline in the projected distribution, and 8 diffracted arrays may exist on both sides of the primitive array along an axis 90 degrees to the baseline. Therefore, the location of the codeword may possibly correspond to any of the arrays. While a mapping of image locations to distribution locations (determined for an undistorted distribution) may be used to attempt to identify an associated array for an identified codeword, distortions (such as a pincushion distortion) may cause the mapping to associate an incorrect array for one or more identified codewords. For example, a mapping may indicate one array while the correct array neighbors the indicated array as a result of the distortion.

As noted above, as the location of an object changes in a scene, the associated disparity calculated based on the location of the identified codeword in the image (as described above) may wrap around from a minimum disparity to a maximum disparity or from a maximum disparity to a minimum disparity (indicating a change in which array of the projected distribution corresponds to the location). Wrap around may also occur in the direction 90 degrees to the baseline axis (such as if measuring a difference in the y coordinate values between the location of the codeword in the image and the center of the array in the image).

To correctly determine a disparity, the device 400 may determine to which array an image region including an identified codeword corresponds. For example, the device 400 may determine a row of arrays and a column of arrays in the distribution (such as the distribution 300 in FIG. 3 including the primitive array 302 and the various diffracted arrays 304) to determine the specific array.

The device 400, in determining the location, determines the codeword in an array (as described above) and which array of the projected distribution corresponds to the region in the image. As noted above, the device 400 may include a mapping of different locations in an image from the receiver 402 to corresponding arrays in the projected distribution. The mapping may be calculated or otherwise based on the distribution not including a pincushion distortion or other optical distortions. In some implementations, the size of a codeword 90 degrees to the baseline is large enough so that the maximum displacement of a light point caused by the distortion is less than the size of the codeword along such direction.

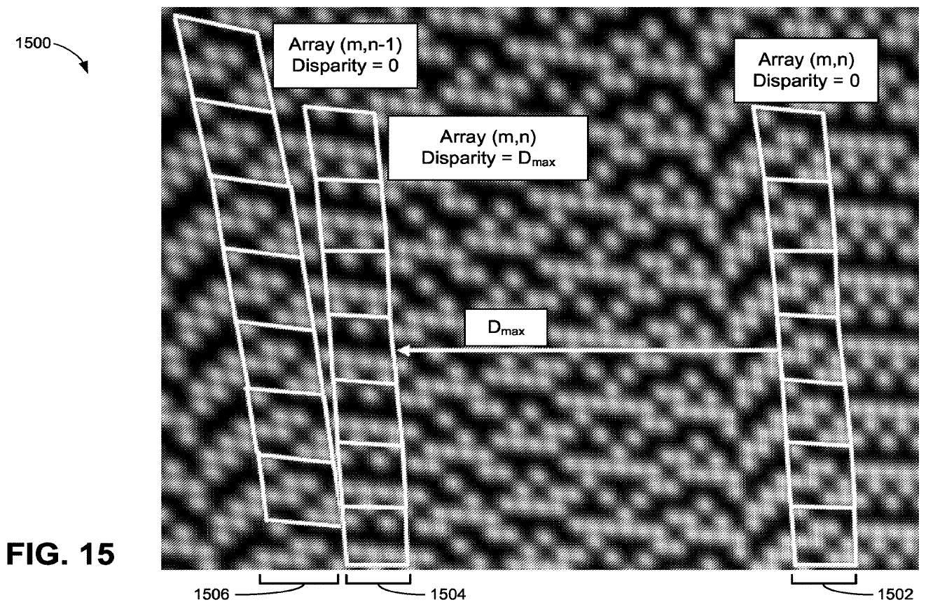

FIG. 15 shows an example depiction of displacements of light points in a distribution 1500 (as captured in an image) that is caused by distortion (such as a pincushion distortion). In the example, the baseline is in the horizontal direction of the distribution 1500. An array may include columns of seven unique codewords (such as 4×4 codewords) in the vertical direction (indicated by the column of boxes 1502). The column of boxes 1502 indicates 7 codewords corresponding to a first array in the distribution 1500 (array (m,n)), and the column of boxes 1506 indicates the same 7 codewords corresponding to an array neighboring the first array (array (m,n−1)). The maximum disparity that may be calculated is indicated by Dₘₐₓ (such as 192 image pixels in the above example with reference to FIG. 13). The location of the column of boxes 1502 in the image when the disparity=Dₘₐₓ is shifted by a number of image pixels along the baseline equal to Dₘₐₓ (depicted by column 1504). The disparity may wrap around between 0 and Dₘₐₓ. Therefore, if no distortion exists, the location of the column of boxes 1506 should be at the location of the column 1504 in the image. The displacement of light points caused by the distortion may be visualized by comparing column 1504 to column of boxes 1506 (which is shifted left and up from column 1504 in an image as a result of the distortion).

In determining a corresponding array for an image region, the device 400 may determine the column of arrays and may determine the row of arrays in the projected distribution. In some implementations, the maximum displacement of a light point in a vertical direction is less than the size of a codeword in the vertical direction in the image (with the baseline along the horizontal direction in the image). For example, in comparing column of boxes 1506 to column 1504, the displacement in the vertical direction of a codeword in 1504 is less than the height of the codeword in the image. Since displacement in the vertical direction is less than the height of a codeword, the device 400 may determine that the row of arrays of the distorted distribution corresponding to an image region is the closest row of arrays corresponding to the image region if no distortion exists. For example, a mapping of arrays to portions of the image (which may be calculated based on no distortion in the distribution) may be used to determine the row of arrays for the image region (with the identified codeword) without any transform or further calculation.

The device 400 may also determine the column of arrays corresponding to the image region. Because of disparities being calculated along the horizontal axis (the baseline), the above described mapping may indicate an incorrect column of arrays. For example, an array (m,n) may be determined using the mapping, but the codeword in the image region may actually correspond to neighboring array (m,n−1). In some implementations, the device 400 uses the mapping to determine two neighboring columns of arrays as the possible column for an image region. If the maximum displacement of a codeword in the vertical direction is less than, for example, half the height of the primitive array in the image (such as less than the height of the codeword in the image), the closest row of arrays corresponds indicated by the mapping corresponds to the image region. In this manner, the device 400 may use the mapping to determine two neighboring arrays (such as a left array and a right array) in the distribution as possible arrays associated with the image region including the identified codeword.

In some implementations, to select the associated array from the two arrays, the device 400 may determine a first disparity based on the first array and determine a second disparity based on the second array (such as described above regarding determining a disparity). In some implementations, the device 400 selects the array associated with the smaller of the first disparity or the second disparity. In some other implementations, the device 400 does not select an array associated with a disparity that is greater than a maximum disparity. In this manner, a disparity may be determined for each identified codeword in an image, and a depth value may be determined for each disparity (taking into account optical distortions of the distribution). As noted above, the depth values may be used in generating a depth map. The depth map can be used for active depth sensing based applications (such as facial recognition, object detection, obstacle avoidance, augmented reality, and so on).

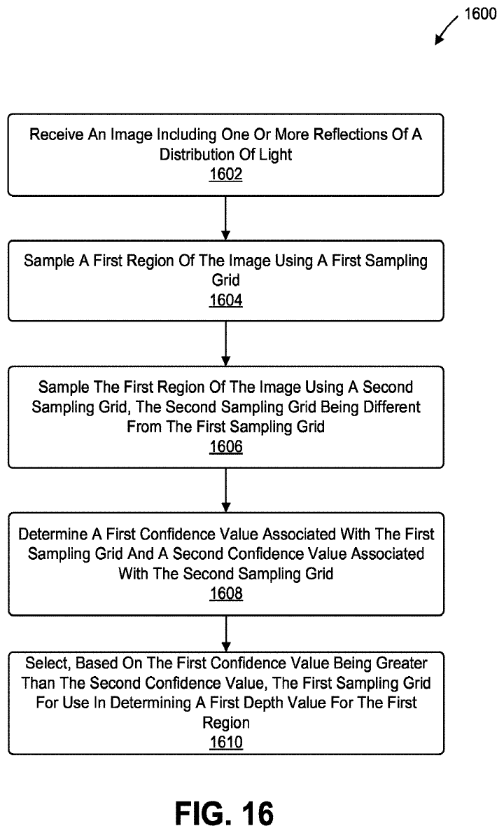

FIG. 16 is a flow diagram illustrating an example of a process 1600 of determining an exposure duration for a number of frames using the techniques described herein. At block 1602, the process 1600 includes receiving an image including one or more reflections of a distribution of light. For instance, the distribution of light may include a distribution of light points. In one illustrative example, the distribution of light can include the distribution 300 of FIG. 3.

At block 1604, the process 1600 includes sampling a first region of the image using a first sampling grid. At block 1606, the process 1600 includes sampling the first region of the image using a second sampling grid, the second sampling grid being different from the first sampling grid. In some cases, an arrangement of sampling points of the second sampling grid differs from an arrangement of sampling points of the first sampling grid. In some examples, the arrangement of sampling points of the first sampling grid includes a first spacing between sampling points of the first sampling grid. In such examples, the arrangement of sampling points of the second sampling grid may include a second spacing between sampling points of the second sampling grid. In some aspects, the first spacing and the second spacing are along a baseline axis and an axis orthogonal to the baseline axis. As described herein, the baseline axis (e.g., the baseline 112 shown in FIG. 1) is associated with a transmitter (e.g., emitter 102 of FIG. 1) that transmits the distribution of light and a receiver (e.g., receiver 108 of FIG. 1) that captures the image. In some examples, a total number of sampling points of the second sampling grid differs from a total number of sampling points of the first sampling grid. In some cases, the first sampling grid is an isotropic sampling grid and the second sampling grid is an anisotropic sampling grid

At block 1608, the process 1600 includes determining a first confidence value associated with the first sampling grid and a second confidence value associated with the second sampling grid. For instance, as described herein, the process 1600 can include applying the first sampling grid to the first region of the image and then computing or determining the first confidence value. The process 1600 can further include applying the second sampling grid to the first region of the image and then computing or determining the second confidence value. In some examples, the process 1600 can determine the first confidence value associated with the first sampling grid at least in part by determining the first confidence value for the first image sample. In some examples, the process 1600 can determine the second confidence value associated with the second sampling grid at least in part by determining the second confidence value for the second image sample.

At block 1610, the process 1600 includes selecting, based on the first confidence value being greater than the second confidence value, the first sampling grid for use in determining a first depth value for the first region. In some examples, the process 1600 can select the first sampling grid for use in determining the first depth value for the first region at least in part by selecting the first image sample based on the first confidence value being greater than the second confidence value.

In some examples, the process 1600 can include determining a first image sample based on the sampling of the first region of the image using the first sampling grid. The process 1600 can further include determining the first depth value for the first region based on the first image sample. In some cases, the process 1600 can include identifying in the first region a first codeword in an array of the distribution of light (e.g., the primitive array 302 or one of the diffracted arrays 304 of the distribution 300 of light in FIG. 3) based on the first image sample. The process 1600 can include determining a first disparity based on a location of the first codeword in the array, wherein determining the first depth value is based on the first disparity. In some aspects, the process 1600 can include sampling a second region of the image using a third sampling grid to generate a second image sample. The process 1600 can include determine a second depth value based on the second image sample. The process 1600 can continue such a process to determine any number of depth values for the received image.

In some examples, the process 1600 can include determining a first image sample based on the sampling of the first region of the image using the first sampling grid. The process 1600 can include determining a second image sample based on the sampling of the first region of the image using the second sampling grid. In some cases, the process 1600 can include comparing the first image sample and the second image sample. The process 1600 can include selecting the first image sample to be used for determining the first depth value based on comparing the first image sample and the second image sample.

In some cases, the process 1600 can include generating a depth map based on the image. For instance, the depth map may include a plurality of depth values including the first depth value. The plurality of depth values indicate one or more depths of one or more objects in a scene captured in the image.

In some examples, the processes described herein (e.g., process 900, process 1200, process 1600, and/or other process described herein) may be performed by a computing device or apparatus. In some examples, the process 900, the process 1200, the process 1600, and/or other process described herein can be performed by the device 400 of FIG. 4, the active depth sensing system 100 of FIG. 1 (e.g., implemented in or by the device 400), and/or other device or system configured to perform the operations of process 900, process 1200, process 1600, and/or other process described herein.

The computing device can include any suitable device, such as a mobile device (e.g., a mobile phone), a desktop computing device, a tablet computing device, an extended reality device (e.g., a virtual reality (VR) headset such as a head-mounted display (HMD), an augmented reality (AR) headset such as an HMD, AR glasses, or other wearable device), a wearable device (e.g., a network-connected watch or smartwatch), a server computer, a vehicle or computing device of a vehicle, a robotic device, a television, and/or any other computing device with the resource capabilities to perform the processes described herein, including the process 900, the process 1200, and the process 1600. In some cases, the computing device or apparatus may include various components, such as one or more input devices, one or more output devices, one or more processors, one or more microprocessors, one or more microcomputers, one or more cameras, one or more sensors, and/or other component(s) that can be configured to carry out one or more of the operations of the processes described herein. In some examples, the computing device may include a receiver or sensor configured to capture the image. In some cases, the computing device may include a transmitter configured to transmit the distribution of light. For instance, the transmitter may be separated from the receiver by a baseline distance along a baseline axis (e.g., the baseline 112 of FIG. 1). In some examples, the computing device may include one or more signal processors configured to process the image before decoding the processed image by the one or more processors. In some examples, the computing device may include a display, a network interface configured to communicate and/or receive the data, any combination thereof, and/or other component(s). The network interface may be configured to communicate and/or receive Internet Protocol (IP) based data or other type of data. In some aspects, the apparatus or computing device can include one or more sensors (e.g., one or more inertial measurement units (IMUs), such as one or more gyrometers, one or more accelerometers, any combination thereof, and/or other sensor).

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes 900, 1200, and 1600 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 900, the process 1200, the process 1600, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 406 in the example device 400 of FIG. 4) comprising instructions that, when executed by the processor (or a signal processor or another suitable component), cause the device to perform one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits, and instructions described in connection with the embodiments disclosed herein may be executed by one or more processors, such as the processor 404 or the signal processor 412 in the example device 400 in FIG. 4. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. For example, while two sampling grids may be described in some examples, any suitable number of sampling grids may be used to perform aspects of the present disclosure. Also, while two regions of an image may be described for sampling and attempting to determine depth values or other measurements (such as disparities, signatures, confidence values, and so on), any number of regions of an image may be sampled. Additionally, the functions, steps or actions of the method claims in accordance with aspects described herein need not be performed in any particular order unless expressly stated otherwise. For example, one or more steps of the described example operations may be performed in any order and at any frequency as suitable. Furthermore, although elements or components may be described or claimed in the singular, the plural is contemplated unless limitation to the singular is explicitly stated.

For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems; networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flow diagram, a flowchart, a data flow diagram, a structure diagram, or a block diagram. Although a flow diagram may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly; to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” and/or “at least one of A or B” means A, B, or A and B. In another example, claim language reciting “at least one of A, B, and C” and/or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1: A device for active depth sensing, comprising: a memory; and one or more processors configured to: receive an image, the image including one or more reflections of a distribution of light; sample a first region of the image using a first sampling grid; sample the first region of the image using a second sampling grid, the second sampling grid being different from the first sampling grid; determine a first confidence value associated with the first sampling grid and a second confidence value associated with the second sampling grid; and based on the first confidence value being greater than the second confidence value, select the first sampling grid for use in determining a first depth value for the first region.

Aspect 2: The device of Aspect 1, wherein the distribution of light is a distribution of light points.

Aspect 3: The device of any of Aspects 1 or 2, wherein the one or more processors configured to: determine a first image sample based on the sampling of the first region of the image using the first sampling grid; and determine the first depth value for the first region based on the first image sample.

Aspect 4: The device of Aspect 3, wherein the one or more processors are further configured to: identify in the first region a first codeword in an array of the distribution of light based on the first image sample; and determine a first disparity based on a location of the first codeword in the array, wherein determining the first depth value is based on the first disparity.

Aspect 5: The device of any of Aspects 3 or 4, wherein the one or more processors configured to: sample a second region of the image using a third sampling grid to generate a second image sample; and determine a second depth value based on the second image sample.

Aspect 6: The device of any of Aspects 1 to 5, wherein an arrangement of sampling points of the second sampling grid differs from an arrangement of sampling points of the first sampling grid.

Aspect 7: The device of Aspect 6, wherein the arrangement of sampling points of the first sampling grid includes a first spacing between sampling points of the first sampling grid, and wherein the arrangement of sampling points of the second sampling grid includes a second spacing between sampling points of the second sampling grid.

Aspect 8: The device of Aspect 7, wherein the first spacing and the second spacing are along a baseline axis and an axis orthogonal to the baseline axis, the baseline axis being associated with a transmitter that transmits the distribution of light and a receiver that captures the image.

Aspect 9: The device of any of Aspects 1 to 8, wherein a total number of sampling points of the second sampling grid differs from a total number of sampling points of the first sampling grid.

Aspect 10: The device of any of Aspects 1 to 9, wherein the first sampling grid is an isotropic sampling grid and the second sampling grid is an anisotropic sampling grid.

Aspect 11: The device of any of Aspects 1 to 10, wherein the one or more processors are further configured to: determine a first image sample based on the sampling of the first region of the image using the first sampling grid; determine a second image sample based on the sampling of the first region of the image using the second sampling grid; compare the first image sample and the second image sample; and select the first image sample to be used for determining the first depth value based on comparing the first image sample and the second image sample.

Aspect 12: The device of Aspect 11, wherein: to determine the first confidence value associated with the first sampling grid, the one or more processors are configured to determine the first confidence value for the first image sample; to determine the second confidence value associated with the second sampling grid, the one or more processors are configured to determine the second confidence value for the second image sample; and to select the first sampling grid for use in determining the first depth value for the first region, the one or more processors are configured to select the first image sample based on the first confidence value being greater than the second confidence value.

Aspect 13: The device of any of Aspects 1 to 12, further comprising a receiver configured to capture the image.

Aspect 14: The device of Aspect 13, further comprising a transmitter configured to transmit the distribution of light, wherein the transmitter is separated from the receiver by a baseline distance along a baseline axis.

Aspect 15: The device of any of Aspects 1 to 14, further comprising one or more signal processors configured to process the image before decoding the processed image by the one or more processors.

Aspect 16: The device of any of Aspects 1 to 15, wherein the one or more processors are configured to generate a depth map based on the image, wherein the depth map includes a plurality of depth values including the first depth value, and wherein the plurality of depth values indicate one or more depths of one or more objects in a scene captured in the image.

Aspect 17: A method for active depth sensing, comprising: receiving an image including one or more reflections of a distribution of light; sampling a first region of the image using a first sampling grid; sampling the first region of the image using a second sampling grid, the second sampling grid being different from the first sampling grid; determining a first confidence value associated with the first sampling grid and a second confidence value associated with the second sampling grid; and based on the first confidence value being greater than the second confidence value, selecting the first sampling grid for use in determining a first depth value for the first region.

Aspect 18: The method of Aspect 17, wherein the distribution of light is a distribution of light points.

Aspect 19: The method of any of Aspects 17 or 18, further comprising: determining a first image sample based on the sampling of the first region of the image using the first sampling grid; and determining the first depth value for the first region based on the first image sample.

Aspect 20: The method of Aspect 19, further comprising: identifying in the first region a first codeword in an array of the distribution of light based on the first image sample; and determining a first disparity based on a location of the first codeword in the array, wherein determining the first depth value is based on the first disparity.

Aspect 21: The method of any of Aspects 19 or 20, further comprising: sampling a second region of the image using a third sampling grid to generate a second image sample; and determining a second depth value based on the second image sample.

Aspect 22: The method of any of Aspects 17 to 21, wherein an arrangement of sampling points of the second sampling grid differs from an arrangement of sampling points of the first sampling grid.

Aspect 23: The method of Aspect 22, wherein the arrangement of sampling points of the first sampling grid includes a first spacing between sampling points of the first sampling grid, and wherein the arrangement of sampling points of the second sampling grid includes a second spacing between sampling points of the second sampling grid.

Aspect 24: The method of Aspect 23, wherein the first spacing and the second spacing are along a baseline axis and an axis orthogonal to the baseline axis, the baseline axis being associated with a transmitter that transmits the distribution of light and a receiver that captures the image.

Aspect 25: The method of any of Aspects 17 to 24, wherein a total number of sampling points of the second sampling grid differs from a total number of sampling points of the first sampling grid.

Aspect 26: The method of any of Aspects 17 to 25, wherein the first sampling grid is an isotropic sampling grid and the second sampling grid is an anisotropic sampling grid.

Aspect 27: The method of any of Aspects 17 to 26, further comprising: determining a first image sample based on the sampling of the first region of the image using the first sampling grid; determining a second image sample based on the sampling of the first region of the image using the second sampling grid; comparing the first image sample and the second image sample; and selecting the first image sample to be used for determining the first depth value based on comparing the first image sample and the second image sample.

Aspect 28: The method of Aspect 27, wherein: determining the first confidence value associated with the first sampling grid includes determining the first confidence value for the first image sample; determining the second confidence value associated with the second sampling grid includes determining the second confidence value for the second image sample; and selecting the first sampling grid for use in determining the first depth value for the first region includes selecting the first image sample based on the first confidence value being greater than the second confidence value.

Aspect 29: The method of any of Aspects 17 to 28, further comprising capturing the image using a receiver.

Aspect 30: The method of Aspect 29, further comprising transmitting the distribution of light using a transmitter, wherein the transmitter is separated from the receiver by a baseline distance along a baseline axis.

Aspect 31: The method of any of Aspects 17 to 30, further comprising processing, using one or more signal processors, the image before decoding the processed image.

Aspect 32: The method of any of Aspects 17 to 31, further comprising generating a depth map based on the image, wherein the depth map includes a plurality of depth values including the first depth value, and wherein the plurality of depth values indicate one or more depths of one or more objects in a scene captured in the image.

Aspect 33: A non-transitory computer-readable storage medium having stored thereon instructions which, when executed by one or more processors, cause the one or more processors to perform any of the operations of aspects 1 to 32.

Aspect 34: An apparatus comprising means for performing any of the operations of aspects 1 to 32.

What is claimed is:

1. A device for active depth sensing, comprising:
a memory; and
one or more processors configured to:
receive an image, the image including one or more reflections of a distribution of light;
sample a first region of the image using a first sampling grid;
sample the first region of the image using a second sampling grid, the second sampling grid being different from the first sampling grid;
determine a first confidence value associated with the first sampling grid and a second confidence value associated with the second sampling grid; and
based on the first confidence value being greater than the second confidence value, select the first sampling grid for use in determining a first depth value for the first region.

2. The device of claim 1, wherein the distribution of light is a distribution of light points.

3. The device of claim 1, wherein the one or more processors configured to:
determine a first image sample based on the sampling of the first region of the image using the first sampling grid; and
determine the first depth value for the first region based on the first image sample.

4. The device of claim 3, wherein the one or more processors are further configured to:
identify in the first region a first codeword in an array of the distribution of light based on the first image sample; and
determine a first disparity based on a location of the first codeword in the array, wherein determining the first depth value is based on the first disparity.

5. The device of claim 4, wherein the one or more processors configured to:
sample a second region of the image using a third sampling grid to generate a second image sample; and
determine a second depth value based on the second image sample.

6. The device of claim 1, wherein an arrangement of sampling points of the second sampling grid differs from an arrangement of sampling points of the first sampling grid.

7. The device of claim 6, wherein the arrangement of sampling points of the first sampling grid includes a first spacing between sampling points of the first sampling grid, and wherein the arrangement of sampling points of the second sampling grid includes a second spacing between sampling points of the second sampling grid.

8. The device of claim 7, wherein the first spacing and the second spacing are along a baseline axis and an axis orthogonal to the baseline axis, the baseline axis being associated with a transmitter that transmits the distribution of light and a receiver that captures the image.

9. The device of claim 1, wherein a total number of sampling points of the second sampling grid differs from a total number of sampling points of the first sampling grid.

10. The device of claim 1, wherein the first sampling grid is an isotropic sampling grid and the second sampling grid is an anisotropic sampling grid.

11. The device of claim 1, wherein the one or more processors are further configured to:
determine a first image sample based on the sampling of the first region of the image using the first sampling grid;
determine a second image sample based on the sampling of the first region of the image using the second sampling grid;
compare the first image sample and the second image sample; and
select the first image sample to be used for determining the first depth value based on comparing the first image sample and the second image sample.

12. The device of claim 11, wherein:
to determine the first confidence value associated with the first sampling grid, the one or more processors are configured to determine the first confidence value for the first image sample;
to determine the second confidence value associated with the second sampling grid, the one or more processors are configured to determine the second confidence value for the second image sample; and
to select the first sampling grid for use in determining the first depth value for the first region, the one or more processors are configured to select the first image sample based on the first confidence value being greater than the second confidence value.

13. The device of claim 1, further comprising a receiver configured to capture the image.

14. The device of claim 13, further comprising a transmitter configured to transmit the distribution of light, wherein the transmitter is separated from the receiver by a baseline distance along a baseline axis.

15. The device of claim 1, further comprising one or more signal processors configured to process the image before decoding the processed image by the one or more processors.

16. The device of claim 1, wherein the one or more processors are configured to generate a depth map based on the image, wherein the depth map includes a plurality of depth values including the first depth value, and wherein the plurality of depth values indicate one or more depths of one or more objects in a scene captured in the image.

17. A method for active depth sensing, comprising:
receiving an image including one or more reflections of a distribution of light;
sampling a first region of the image using a first sampling grid;
sampling the first region of the image using a second sampling grid, the second sampling grid being different from the first sampling grid;
determining a first confidence value associated with the first sampling grid and a second confidence value associated with the second sampling grid; and
based on the first confidence value being greater than the second confidence value, selecting the first sampling grid for use in determining a first depth value for the first region.

18. The method of claim 17, wherein the distribution of light is a distribution of light points.

19. The method of claim 17, further comprising:
determining a first image sample based on the sampling of the first region of the image using the first sampling grid; and
determining the first depth value for the first region based on the first image sample.

20. The method of claim 19, further comprising:
identifying in the first region a first codeword in an array of the distribution of light based on the first image sample; and
determining a first disparity based on a location of the first codeword in the array, wherein determining the first depth value is based on the first disparity.

21. The method of claim 20, further comprising:
sampling a second region of the image using a third sampling grid to generate a second image sample, the third sampling grid being different from at least one of the first sampling grid and the second sampling grid; and
determining a second depth value based on the second image sample.

22. The method of claim 17, wherein an arrangement of sampling points of the second sampling grid differs from an arrangement of sampling points of the first sampling grid.

23. The method of claim 22, wherein the arrangement of sampling points of the first sampling grid includes a first spacing between sampling points of the first sampling grid, and wherein the arrangement of sampling points of the second sampling grid includes a second spacing between sampling points of the second sampling grid.

24. The method of claim 23, wherein the first spacing and the second spacing are along a baseline axis and an axis orthogonal to the baseline axis, the baseline axis being associated with a transmitter that transmits the distribution of light and a receiver that captures the image.

25. The method of claim 17, wherein a total number of sampling points of the second sampling grid differs from a total number of sampling points of the first sampling grid.

26. The method of claim 17, wherein the first sampling grid is an isotropic sampling grid and the second sampling grid is an anisotropic sampling grid.

27. The method of claim 17, further comprising:
determining a first image sample based on the sampling of the first region of the image using the first sampling grid;
determining a second image sample based on the sampling of the first region of the image using the second sampling grid;
comparing the first image sample and the second image sample; and
selecting the first image sample to be used for determining the first depth value based on comparing the first image sample and the second image sample.

28. The method of claim 27, wherein:
determining the first confidence value associated with the first sampling grid includes determining the first confidence value for the first image sample;
determining the second confidence value associated with the second sampling grid includes determining the second confidence value for the second image sample; and
selecting the first sampling grid for use in determining the first depth value for the first region includes selecting the first image sample based on the first confidence value being greater than the second confidence value.

29. The method of claim 17, further comprising:
transmitting the distribution of light.

30. The method of claim 17, further comprising:
generating a depth map based on the image, wherein the depth map includes a plurality of depth values including the first depth value, and wherein the plurality of depth values indicate one or more depths of one or more objects in a scene captured in the image.
